(19) United States
(12) Patent Application Publication
(10) Pub. No.: US 2021/0111900 A1
(43) Pub. Date: Apr. 15, 2021

(54) VERIFICATION INFORMATION ATTACHING DEVICE, VERIFICATION DEVICE, INFORMATION MANAGEMENT SYSTEM, METHOD, AND PROGRAM

(71) Applicant: NEC CORPORATION, Tokyo (JP)

(72) Inventor: Masaki INOKUCHI, Minato-ku, Tokyo (JP)

(73) Assignee: NEC CORPORATION, Tokyo (JP)

(21) Appl. No.: 16/498,504

(22) PCT Filed: Mar. 30, 2017
(86) PCT No.: PCT/JP2017/013473

§ 371 Date: Sep. 27, 2019

(51) Int. Cl. H04L 9/32; G06F 21/64; G06F 21/60

(52) U.S. Cl. CPC H04L 9/3247; G06F 21/602; G06F 21/64

(57) ABSTRACT

A verification information attaching device (51) of the present invention is provided with a nonce setting means (511) for performing a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set.

### TECHNICAL FIELD

The present invention relates to a verification information attaching device, a verification device, an information management system, a verification information attaching method, and a verification information attaching program for determining correctness of data.

### BACKGROUND ART

There is a demand for continuously providing services even in a case where a failure occurs or a malicious terminal exists. For such a demand, for example, it is conceivable to utilize blockchain technology.

The blockchain generally operates in a distributed manner, without depending on a specific centralized management server. In addition, it is possible to share a ledger that is difficult to be falsified with terminals in a system, and to use the ledger for verification of data, application information, other management information and authentication information, or the like.

As a method of achieving falsification difficulty of the blockchain, for example, a consensus algorithm called Proof of Work (PoW) is used.

In PoW, for certain data, processing is performed to search for a value to be set in a nonce area included in the data so that the value obtained when the data is processed by a one-way function satisfies a predetermined rule (hereinafter referred to simply as a processing of searching for a nonce).

At this time, for example, a hash function can be used as the one-way function. In addition, the rule at that time can be set as “the hash value is less than or equal to the threshold value (target value)”. Generally, the processing of searching for a nonce cannot be efficiently performed due to the nature of the one-way function, so that a device that performs the processing repeats work of setting an appropriate value for the nonce and confirming whether or not the rule is satisfied, in practice. The work of such setting and confirmation is performed in parallel in many nodes, and the node that finds the nonce satisfying the rule earliest transmits information to other nodes, whereby a state of the data including a value of the nonce is determined in all the nodes on the basis of the information (a consensus is achieved).

Features of PoW include a point that security is generally dependent on a total computing capacity and a point that it is easy to increase the number of nodes since a consensus is achieved on the basis of the amount of work (hash computation). In addition, features of a BFT-based algorithm include, generally, a point that security is dependent on the total number of terminals and a point that the number of nodes cannot be increased, since a consensus is achieved in a voting format.

Note that, the blockchain is roughly divided into two types of a public type in which anyone can participate, and a private type in which only nodes in a determined organization can participate.

Regarding falsification resistance in the blockchain, for example, Patent Literature 1 describes an example of an open type blockchain in which integrity of transaction information is secured by a digital signature using a public key cryptosystem and a hash function.

### CITATION LIST

### Patent Literature

Patent Literature 1: Japanese Patent Application Laid-Open No. 2016-218633

### SUMMARY OF INVENTION

### Technical Problem

The present invention mainly assumes a PoW-based blockchain of the private type. Hereinafter, first, a data structure and falsification resistance of a general blockchain will be described before describing falsification resistance of the private blockchain.

FIG. 28 is an explanatory diagram showing an example of a data structure of a general blockchain. As shown in FIG. 28, a blockchain has a configuration in which data each having a predetermined data structure called a block are connected together. In addition, each block includes the hash value of the previous block, a nonce, and data stored in the block. For example, a block n includes the hash value of a block n−1, a nonce n, and data n. Note that, the data n may be arbitrary data such as transaction information.

Here, the nonce is verification information that affects the falsification resistance of the blockchain, and specifically, has a role as verification information set in a process of PoW.

Next, a general block addition flow in such a blockchain will be described. For example, the following operations (1) to (5) are performed, whereby the block is added to the blockchain.

(1) A terminal wishing to record information in a blockchain notifies, of the information, any or all of terminals participating in the blockchain.

(2) Each terminal checks integrity of the received information, and generates a block if there is no problem.

(3) Each terminal starts PoW for the generated block.

(4) A terminal that has ended PoW notifies all the terminals of the block in which a nonce found in the PoW is set.

(5) Each of the terminals notified of the block in which the nonce is set checks integrity of the hash value and the information stored in the block, and if there is no problem, the block is added at the end of the blockchain managed by the terminal itself.

Note that, in the above operation (2), a method of checking the integrity of the received information depends on an application using the blockchain. In addition, when the block is generated, a plurality of pieces of information can be combined into one block.

In addition, in the PoW operation of (3) above, each terminal further performs the following operation.

(3-1) Each terminal first sets a random nonce (nonce candidate) to the generated block.

(3-2) Next, each terminal confirms whether the hash value of the block satisfies a predetermined rule (for example, whether it is less than or equal to a certain target value).

(3-3) If the rule is satisfied, processing is ended, and if the rule is not satisfied, the set nonce is changed, and the processing returns to (3-2).

Note that, all the terminals notified of the information perform the PoW operation of (3) above in parallel simultaneously. Then, a terminal that has ended PoW earliest is regarded as a terminal that has obtained a right to add blocks to the blockchain.

FIG. 29 is an explanatory diagram for explaining falsification resistance of the blockchain. As shown in FIG. 29, it is assumed that a certain terminal falsifies information (“data n” of “block n” in the figure) written in a past block. Then, since the hash value of the block changes, the falsification is detected at an arbitrary verification timing in a case where the changed hash value exceeds the target value. To prevent the falsification from being detected, it is therefore necessary to reset the nonce (“nonce n” in the figure) of the block to a value less than or equal to the target value.

However, since the fact does not change that the hash value of the block changes, it does not match the “hash value of the previous block” (“Hash (block n)” of “block n+1” in the figure) included in the next block. For this reason, it is necessary to reset the nonce not only in the block but also in all the subsequent blocks. Generally, it is said that a large amount of computation (greater than or equal to 50% of the total amount of computation of a node managing the blockchain) is required for falsification.

In the case of the private blockchain, the total amount of computation of the node managing the blockchain is limited. For this reason, in many systems that use the private blockchain, each node is caused to have a secret key for authentication and a public key of another node, and perform signature or the like on a block registered by the node itself by using the secret key of the node itself, whereby it is prevented that the other terminals can perform falsification.

However, even if a countermeasure using such a secret key is taken, in a case where a malicious node exists in the system due to infection with a virus or the like, there is a possibility of falsification. FIG. 30 is an explanatory diagram showing an aspect of falsification of the private blockchain. As shown in FIG. 30, when a node 30-1 in an information management system 300 managing the blockchain is connected to an external server 90 (for example, a server providing high-speed computation resources on the cloud), it is possible to transmit a block in which a nonce is not set to the external server 90, and causes PoW to be performed. Then, the node 30-1 receives a block including a nonce found by the external server 90, and notifies the other nodes of the block as if the node 30-1 itself has found the nonce.

Note that, the number of external servers 90 is not limited to one, and a number of servers ahead of the external server 90 can be connected. When the amount of computation of the external server 90 exceeds 50% of the total amount of computation in the information management system 300, falsification of the blockchain therefore becomes possible.

Note that, as one of the blockchain rules, there is one that a longer chain is trusted in the case of a situation in which a plurality of chains exists, such as a case where a plurality of nodes ends PoW at the same time (Longgest rule). This is because a long chain can be regarded as a chain approved by many management nodes since it can be said that the long chain is a chain for which a large amount of computation is performed.

In a case where a malicious node exists, the malicious node tries to add a block in which unauthorized information is recorded to a chain, but a normal node rejects such a block. FIG. 31 is an explanatory diagram showing an example of a behavior after a case where a malicious node adds an unauthorized block. The example shown in FIG. 31 is an example in which the node 30-1 tries to add an unauthorized block B101. If the block B101 is sent to a cooperating malicious node 30-3, the block B101 is added to a blockchain held by the node 30-3, but if the block B101 is sent to a node 30-2 and a node 30-4 that are normal nodes, the block B101 is rejected. Then, a branch of the blockchain occurs in the system, and from an external node, it appears that two kinds of blockchains exist. At this time, the external node trusts a longer blockchain.

However, if the malicious node is able to add subsequent blocks in a time shorter than a required time for block addition by a normal node group, by using an external computation resource as described above, the blockchain is taken over.

As described above, when a malicious node in the system and an external server collude with each other, there is a possibility that the malicious node can register an unauthorized block, or can falsify a block with the signature of the node itself already registered.

Note that, the above problem occurs not only in the private type, but also occurs similarly in a case where a malicious node uses an external computation resource to increase the amount of computation of the malicious node's PoW in a system in which a plurality of nodes performs PoW and registers information.

In view of the above problem, the present invention aims to improve falsification resistance of shared information in a system in which a plurality of nodes performs PoW and shares the shared information.

### Solution to Problem

A verification information attaching device according to the present invention includes: a nonce setting means that performs a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set, in which the nonce setting means performs a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process.

In addition, a verification device according to the present invention is a verification device that verifies a second data block that is a data block of a predetermined data structure that includes process data that is data obtained as a result of predetermined data process, the process data output from a verification information attaching device, the verification device including a verification means that performs first verification process of verifying the process data included in the second data block by using a public key of the verification information attaching device that is a generation source of the second data block, and second verification process of verifying the second data block or data based on the second data block on a basis of the rule.

In addition, an information management system according to the present invention includes a verification information attaching device and a verification device, in which the verification information attaching device includes a nonce setting means that performs a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set, the nonce setting means performs a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process, and the verification device includes a verification means that performs, on a second data block that is a data block of a predetermined data structure that includes process data that is data obtained as a result of the predetermined data process output from the verification information attaching device, first verification process of verifying the process data included in the second data block by using a public key of the verification information attaching device that is a generation source of the second data block, and second verification process of verifying the second data block or data based on the second data block on a basis of the rule.

In addition, a verification information attaching method according to the present invention includes: performing a setting process once or a predetermined number of times, the setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block;

and a value is set to the nonce area and the process value is actually computed, whereby the nonce is set; and performing a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process.

In addition, a verification information attaching program according to the present invention causes a computer to execute: a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set; and a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process.

### Advantageous Effects of Invention

According to the present invention, the falsification resistance can be improved of the shared information in the system in which the plurality of nodes performs PoW to share information.

### BRIEF DESCRIPTION OF DRAWINGS

FIG. 1 is a configuration diagram showing an example of an information management system of a first exemplary embodiment.

FIG. 2 is a block diagram showing a configuration example of a management node of the first exemplary embodiment.

FIG. 3 is an explanatory diagram showing an example of a data structure of a block of the first exemplary embodiment.

FIG. 4 is a flowchart showing an example of verification information attaching operation of a management node 10.

FIG. 5 is an explanatory diagram showing an example of a signature target area A4 of the first exemplary embodiment.

FIG. 6 is an explanatory diagram showing an example of a rule target area A5 of the first exemplary embodiment.

FIG. 7 is a flowchart showing an example of block verification operation of the management node 10.

FIG. 8 is a block diagram showing another configuration example of the management node of the first exemplary embodiment.

FIG. 9 is an explanatory diagram showing another example of the data structure of the block of the first exemplary embodiment.

FIG. 10 is an explanatory diagram showing an example of an encryption target area A6 and an encrypted data area A6′ of the first exemplary embodiment.

FIG. 11 is an explanatory diagram showing another example of the rule target area A5 of the first exemplary embodiment.

FIG. 12 is a flowchart showing another example of the verification information attaching operation of the management node 10.

FIG. 13 is a flowchart showing another example of the block verification operation of the management node 10.

FIG. 14 is an explanatory diagram showing an example of a data structure of a block of a second exemplary embodiment.

FIG. 15 is an explanatory diagram showing an example of a rule target area A5-k of the second exemplary embodiment.

FIG. 16 is an explanatory diagram showing an example of a signature target area A4-k of the second exemplary embodiment.

FIG. 17 is a flowchart showing an example of verification information attaching operation of the second exemplary embodiment.

FIG. 18 is an explanatory diagram showing a relationship between a required time for the verification information attaching operation according to the second exemplary embodiment and a required time in a case where an external server is used.

FIG. 19 is a flowchart showing an example of block verification operation of the second exemplary embodiment.

FIG. 20 is an explanatory diagram showing an example of the encryption target area A6 of a third exemplary embodiment.

FIG. 21 is an explanatory diagram showing an example of the rule target area A5 of the third exemplary embodiment.

FIG. 22 is a flowchart showing an example of verification information attaching operation of the third exemplary embodiment.

FIG. 23 is an explanatory diagram showing an example of a data structure of a block of the third exemplary embodiment.

FIG. 24 is a flowchart showing an example of block verification operation of the third exemplary embodiment.

FIG. 25 is an explanatory diagram showing an example of expansion of the block by repetition of decryption operation.

FIG. 26 is a schematic block diagram showing a configuration example of a computer according to the exemplary embodiments of the present invention.

FIG. 27 is a block diagram showing an outline of an information verification system of the present invention.

FIG. 28 is an explanatory diagram showing an example of a data structure of a general blockchain.

FIG. 29 is an explanatory diagram for explaining falsification resistance of the blockchain.

FIG. 30 is an explanatory diagram showing an aspect of falsification of a private blockchain.

FIG. 31 is an explanatory diagram showing an aspect of falsification of a private blockchain.

### DESCRIPTION OF EMBODIMENTS

First, a technical concept of the present invention will be briefly described. In the present invention, to suppress use of external resources by a malicious node, each node performs predetermined data process (attaching of a signature and encryption) using a secret key of the node one or more times before the node finishes generating a block in which a nonce is set, in PoW. Then, by including the data (signature and encrypted data) obtained as a result of such data process in the block generated by obtaining PoW, it is made possible to verify correctness of the block by using not only the hash value of the block set to satisfy a rule but also the data.

For example, each node may perform the above data process each time a nonce is repeatedly changed and tried for certain data, the nonce being a value to be set in a predetermined nonce area included in the data so that a process value (hash value) that is a value obtained by processing the data by using a one-way function satisfies the rule. In that case, each node is only required to determine, at the time of verification, whether or not the data after the data process satisfies the rule.

For example, if the data process is attaching of a signature, or encryption, each node is only required to repeat the following processing in processing of setting a nonce.
Processing of setting a nonce candidate in a nonce area
Processing of performing signature or encryption on data including the nonce candidate
Processing of computing a process value of the data on which signature or encryption is performed
Processing of determining whether or not the process value satisfies a rule

In addition, for example, each node may perform data process (signature or encryption) on data including a nonce determined immediately before during performing processing of searching for and setting a nonce one or more times repeatedly. In that case, each node is only required to perform the above data process on at least data including data (a signature and encrypted data) obtained as a result of the data process performed immediately before, in processing of each time, and in the second and subsequent processing, determine whether or not the rule is satisfied for at least the data including the data obtained as a result of the data process performed immediately before.

For example, if the data process is signature, each node is only required to repeatedly perform the following processing as processing of setting one or a predetermined number of nonces for one block.
Processing of setting a nonce in a predetermined nonce area so that data including at least signature performed before that satisfies the rule
   (Note that, processing of setting the first nonce may be normal processing)
Processing of performing signature on data including the set nonce

For example, each node is only required to repeat the above two types of processing while sequentially designating a nonce area as a setting target.

In addition, for example, if the data process is encryption, each node is only required to repeatedly perform the following processing as processing of setting one or a predetermined number of nonces for one block.
Setting a nonce so that data encrypted immediately before satisfies the rule
   (Note that, processing of setting the first nonce may be normal processing)
Processing of performing encryption on data including the set nonce

For example, each node is only required to repeat the above two types of processing while sequentially designating a nonce area as a setting target.

As described above, by including data process using a secret key such as signature or encryption in PoW, it is made impossible to complete PoW by only an external server, and advantage of using the external server is reduced. For example, if an average time taken to complete PoW is smaller in a case where PoW is performed only by the node itself than in a case where the external server is used, an effect is obtained of suppressing use of the external server.

Next, exemplary embodiments of the present invention will be described with reference to the drawings.

### First Exemplary Embodiment

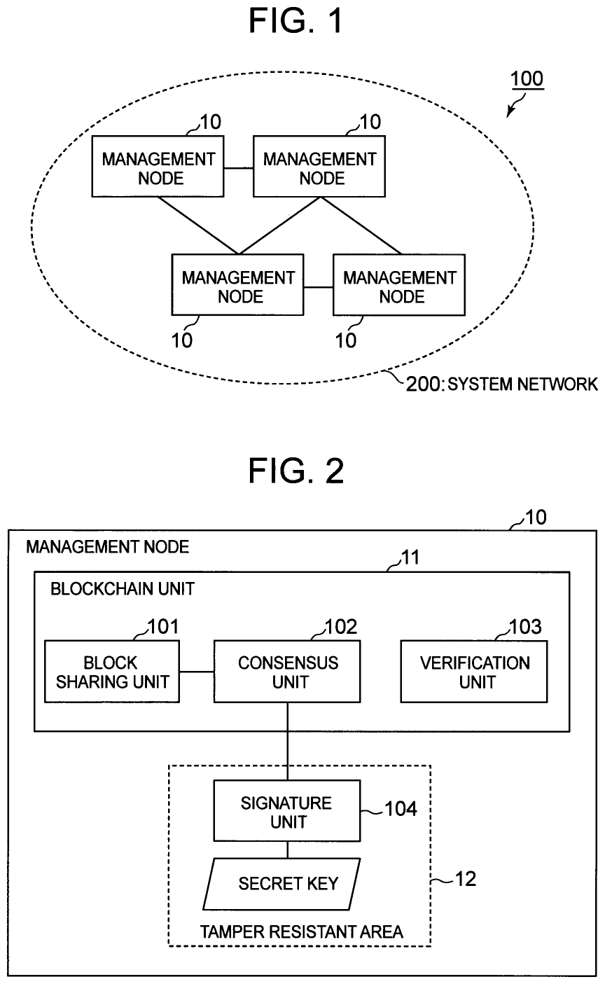

FIG. 1 is a configuration diagram showing an example of an information management system of a first exemplary embodiment. An information management system 100 shown in FIG. 1 includes a plurality of management nodes 10. In this example, the plurality of management nodes 10 is included as nodes having functions of both a verification information attaching device and a verification device. That is, each of the management nodes 10 operates as the verification information attaching device and the verification device of the present invention.

Note that, the information management system 100 may separately include the verification information attaching device and the verification device.

In the present exemplary embodiment, the management nodes 10 are connected to each other via a system network 200 that is a network in the system. The system network 200 may be connected to an external network, but it is preferable that security measures are taken, such as through a firewall.

FIG. 2 is a block diagram showing a configuration example of a management node of the first exemplary embodiment. The management node 10 shown in FIG. 1 includes a blockchain unit 11 and a tamper resistant area 12. In addition, the blockchain unit 11 includes a block sharing unit 101, a consensus unit 102, and a verification unit 103. In addition, the tamper resistant area 12 includes a signature unit 104, and holds a secret key of the node itself. Note that, although not shown, it is assumed that the management node 10 holds a public key of another management node of the system of its own. Note that, there is no particular limitation on a method of holding the public key.

The blockchain unit 11 performs processing for sharing and managing a blockchain in the system to which the management node 10 belongs.

The block sharing unit 101 performs information sharing with another management node 10, such as transmitting a block generated by the node itself to another management node 10, or receiving a block generated by another management node 10. In addition, the block sharing unit 101 may have a function of generating a block in which received information (registration information) and the hash value of the previous block (previous block management information) are set (the other area is not set) and notifying the consensus unit 102 upon receiving the information to be registered in the block.

The consensus unit 102 executes PoW when a block is added to the blockchain. Note that, detailed operation of PoW in the consensus unit 102 will be described later.

The verification unit 103 verifies a block generated by another management node 10. Note that, verification operation in the verification unit 103 will be described later.

The signature unit 104 attaches a signature (electronic signature) to input data by using the secret key of the node itself. At this time, the secret key is stored in the tamper resistant area 12, and cannot be taken out of the tamper resistant area 12.

As a method of realizing the tamper resistant area 12, a security chip (Trusted Platform Module, TPM) may be mentioned. Besides this, the tamper resistant area 12 can also be realized by a device in an area separated in terms of hardware from an information processing device that is a main body of a node, such as an integrated circuit (IC) card or a detachable small device called a dongle, or a security area on a processor unit represented by TrustZone, Intel Software Guard Extensions (SGX), Trusted Execution Environment (TEE), and the like. As described above, the tamper resistant area 12 may be isolated from other process areas in terms of hardware, or may be isolated from other process areas in terms of software.

The signature unit 104 is placed in the tamper resistant area 12 isolated from the other process areas as described above, and attaches a signature to the input data in the tamper resistant area 12. More specifically, by using the secret key, an electronic signature corresponding to input data is generated and output.

Note that, although not shown in FIG. 1, the management node 10 may include a storage unit that stores a copy of the blockchain managed by the system.

In the present exemplary embodiment, the block sharing unit 101, the consensus unit 102, the verification unit 103, and the signature unit 104 are realized by an information processing device that operates according to a program, such as a computer or a CPU included in a device attached thereto.

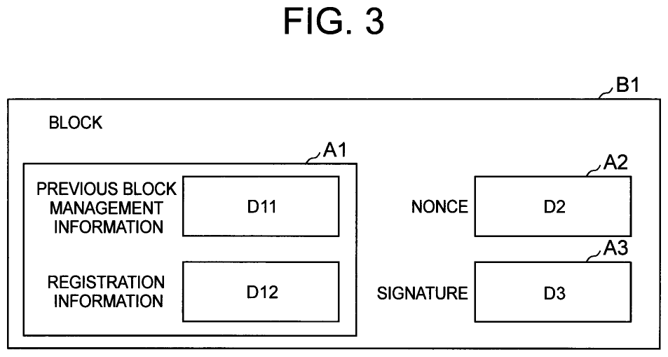

FIG. 3 is an explanatory diagram showing an example of a data structure of a block of the present exemplary embodiment. As shown in FIG. 3, the data structure of a block B1 of the present exemplary embodiment includes a data area A1 in which registration information D11 and the like are set (stored), a nonce area A2 in which a nonce is set, and a signature area A3 in which a signature is set. Data to be set in the data area A1 is not particularly limited. For example, as shown in FIG. 2, registration information and previous block management information may be set in the data area A1. In the present exemplary embodiment, the data area A1 is defined as an area in which arbitrary data is set for which falsification prevention by PoW is desired.

Note that, in FIG. 3, a rectangular frame represents an area, and reference signs in the frame represent data to be set in the area. Note that, the name of the data is attached next to the frame for description. Hereinafter, it is assumed that, in a case where the inside of the frame is blank, it represents that the data is not set in the area (an initial value in the area is set), and in the case other than blank, it represents a content (value) of the data set in the area.

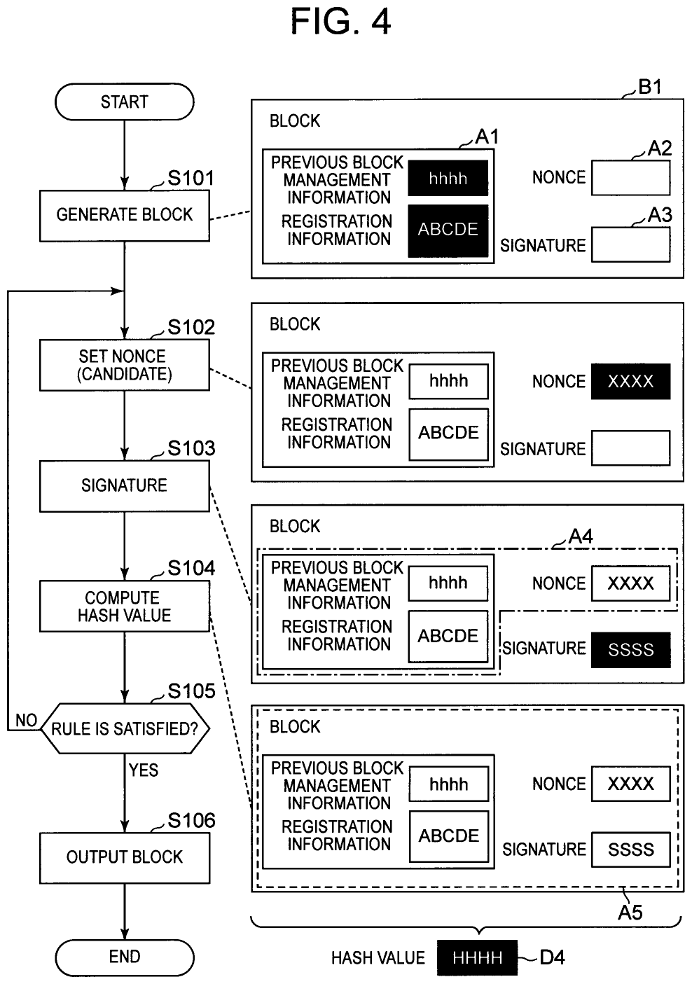

Next, operation of the present exemplary embodiment will be described. First, description will be made of verification information attaching operation by the consensus unit 102 and the signature unit 104 that are parts corresponding to the verification information attaching device of the present invention. FIG. 4 is a flowchart showing an example of the verification information attaching operation of the management node 10. Note that, in this figure, a state is also shown of the block corresponding to each step of the flowchart. Note that, black portions indicate data areas to be processed in respective steps.

In the example shown in FIG. 4, first, the block sharing unit 101 generates a block (step S101). In this example, the block sharing unit 101 is only required to generate the block B1 in which the previous block management information D11 and the registration information D12 are set in the data area A1. At this time, the block sharing unit 101 does not set the nonce area A2 and the signature area A3.

Next, the consensus unit 102 sets a nonce candidate in the nonce area A2 of the block generated in step S101 (step S102).

After step S102, the consensus unit 102 designates the data set in a signature target area A4 of the generated block, and requests the signature unit 104 to generate a signature. The signature unit 104 generates a signature for the designated data on the basis of the request from the consensus unit 102 (step S103).

Note that, the signature target area A4 represents a data area as an attaching target of the signature, that is, a data area to be protected by the signature.

For example, the signature unit 104 may generate a message digest by processing the targeted data with a one-way function, and perform encryption on the generated message digest by using the secret key of the node itself, and use an obtained ciphertext as a signature. Note that, a method for generating the signature is not particularly limited, as long as conversion processing using the secret key is performed on the targeted data.

The signature generated here is set in the signature area A3. In the present invention, such operation in which the consensus unit 102 causes the signature unit 104 to generate a signature by designating the data set in the signature target area A4 of the block, and sets the generated signature in the signature area A3 of the block, is referred to as “attaching of a signature”.

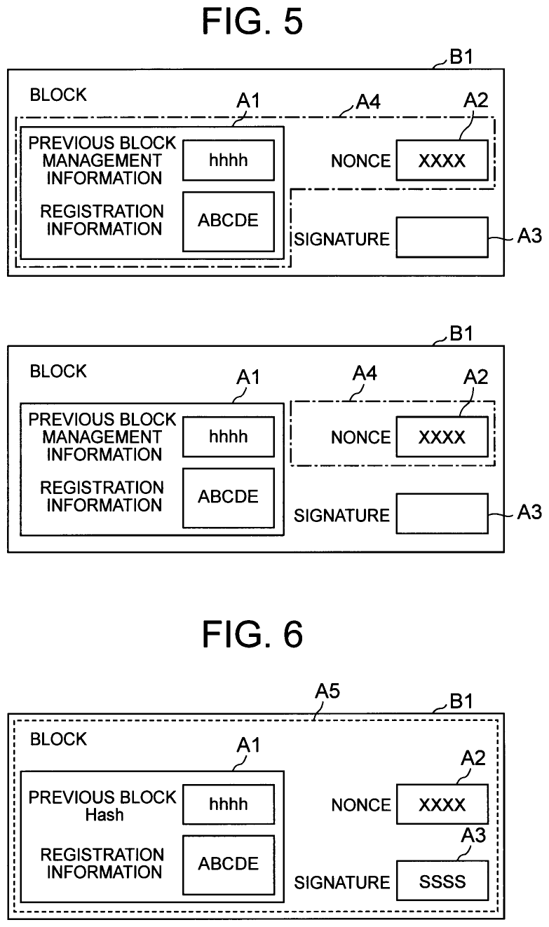

FIG. 5 is an explanatory diagram showing an example of the signature target area A4 of a block B2 of the present exemplary embodiment. As shown in FIG. 5, the signature target area A4 includes at least the nonce area A2. Note that, the signature target area A4 may include only the nonce area A2 (see the top of FIG. 5) or may include all other areas (that is, the nonce area A2 and the data area A1) (see the bottom of FIG. 5).

When the attaching of the signature is ended, the consensus unit 102 computes a hash value D4 by using the data set in a rule target area A5 (step S104). In addition, the hash value D4 computed here corresponds to the above process value. Note that, the rule target area A5 represents a data area used to compute the process value.

FIG. 6 is an explanatory diagram showing an example of the rule target area A5. As shown in FIG. 6, the rule target area A5 includes the entire block, that is, the data area A1, the nonce area A2, and the signature area A3.

Next, the consensus unit 102 confirms whether or not the computed process value satisfies a predetermined rule (for example, whether or not it is less than or equal to a target threshold value) (step S105). In a case where the rule is satisfied, the processing proceeds to step S106, and nonce setting process is ended. On the other hand, in a case where the rule is not satisfied, the consensus unit 102 returns to step S102 and repeats the nonce setting process. That is, the consensus unit 102 adjusts the nonce (candidate) set in the nonce area A2, and repeats the above-described operation until the process value obtained from the rule target area A5 satisfies the rule. Note that, in a case where the consensus unit 102 is notified of a block in which the nonce is set from another management node 10 during the repetition, the nonce setting process may be canceled.

In step S106, the consensus unit 102 outputs a block when the process value (hash value D4) satisfies the rule, as a nonce-set block.

Note that, each of the management nodes 10 is notified of the output block by the block sharing unit 101, and the output block is added to the blockchain held by each management node 10 (block sharing processing).

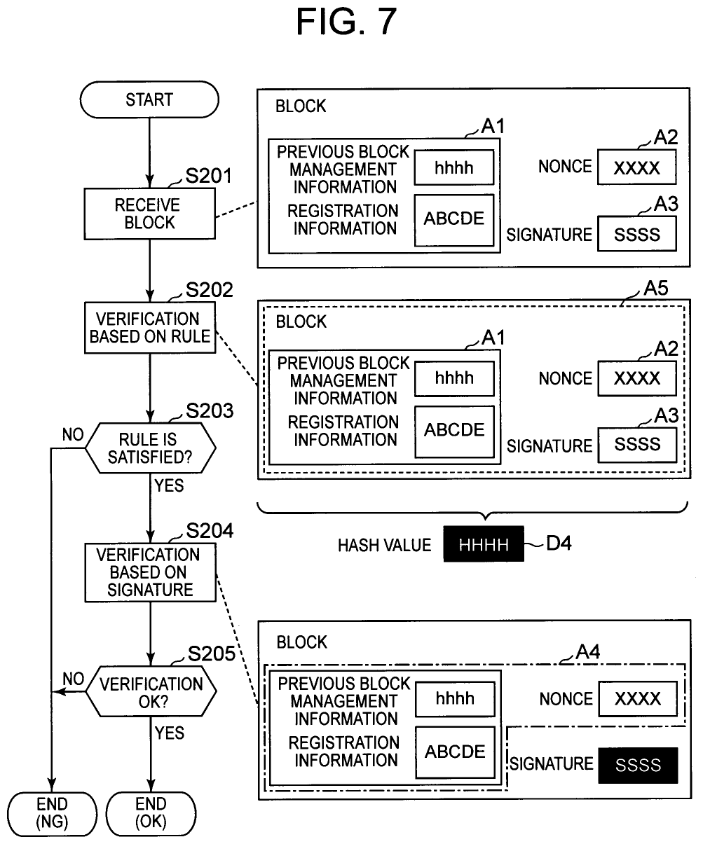

Next, description will be made of block verification operation by the verification unit 103 that is a part corresponding to the verification device of the present invention. FIG. 7 is a flowchart showing an example of the block verification operation of the management node 10.

Note that, also in this figure, a state is also shown of the block corresponding to each step of the flowchart.

In the example shown in FIG. 7, first, the block sharing unit 101 receives a nonce-set block (step S201). In this example, the block sharing unit 101 receives the block B1 in which it is determined that correct values are set in all the data areas.

Next, the verification unit 103 performs verification based on a rule on the block received in step S201 (step S202). The verification unit 103 is only required to determine, for the data set in the rule target area A4 of the block, whether or not the hash value D4 (process value) obtained by applying a one-way function to the data satisfies a predetermined rule (for example, whether or not it is less than or equal to a target threshold value).

In the present invention, such operation of determining, regarding the data area including the nonce area (the above rule target area A4), whether or not a value (process value) obtained by processing the data set in the data area by a one-way function satisfies a rule, is referred to as “verification based on a rule”.

Note that, since the data area A1, the nonce area A2, and the signature area A3 are included in the rule target area A4, by the fact that the rule is satisfied, it is possible to confirm that the determination of the rule is performed after a signature D3 is attached in the verification information attaching side. That is, it can be confirmed that the signature D3 of the block is attached not after nonce search is completed, but at least before it is confirmed that the nonce satisfies the rule.

If the process value satisfies the rule as a result of the verification based on the rule (Yes in step S203), the verification unit 103 proceeds to step S204 to perform verification based on a signature. On the other hand, if the process value does not satisfy the rule (No in step S203), it is determined that the block is not a proper block, and the processing is ended (end by NG determination).

In step S204, the verification unit 103 performs the verification based on the signature on the signature target area A4. More specifically, the verification unit 103 performs verification using the signature D3 set in the signature area A3 and a public key of a generator of the block, on the data set in the signature target area A4.

For example, the verification unit 103 compares a message digest obtained by restoring the signature D3 by using the public key of the generator of the block with a value obtained by processing the data set in the signature target area A4 with a one-way function, and in a case where the digest message matches the value, it is determined that the data is proper data signed by a proper signer (verification OK). On the other hand, in a case where the digest message does not match the value, it is determined that the data is not the proper data signed by the proper signer (verification NG). Note that, a verification method of the signature is not particularly limited, as long as it corresponds to the method of generating the signature performed by the signature unit 104, and involves conversion processing using a public key paired with the secret key of the generator.

In the present invention, such operation of performing, on the data set in the signature target area A4 of the block, conversion processing using the signature D3 set in the signature area A3 of the same block and the public key of the generator of the block and determining correctness of the data, is referred to as “verification based on a signature”.

Since at least the nonce area A2 is included in the signature target area A4, by performing the verification based on the signature, it is possible to confirm whether or not the signature D3 is attached after setting of a nonce D2.

In the next step S205, if it is determined that the targeted data is proper data as a result of the verification based on the signature (Yes in step S205), the verification unit 103 determines that the block is a proper block, and ends the processing (end by OK determination). On the other hand, in a case where it is determined that the block is not the proper data (No in step S205), it is determined that the block is not the proper block, and the processing is ended (end by NG determination).

As described above, by using both the verification based on the rule and the verification based on the signature, it is possible to confirm that the signature D3 of the block is attached not after nonce search is completed nor before the nonce search is started, but each time of the nonce search, and is set in accordance with a proper procedure.

Note that, the determination result at the end of the above verification may be output to a request source of the verification operation as a final verification result. Note that, the verification unit 103 may further perform verification based on the previous block management information before the end by the OK determination.

Note that, in the above example, the verification based on the signature is performed after the verification based on the rule, but the order of these is not particularly limited. For example, the verification based on the rule may be performed after the verification based on the signature, or these may be performed in parallel.

In addition, in the present exemplary embodiment, encryption may be performed instead of the attaching of the signature in the verification information attaching operation.

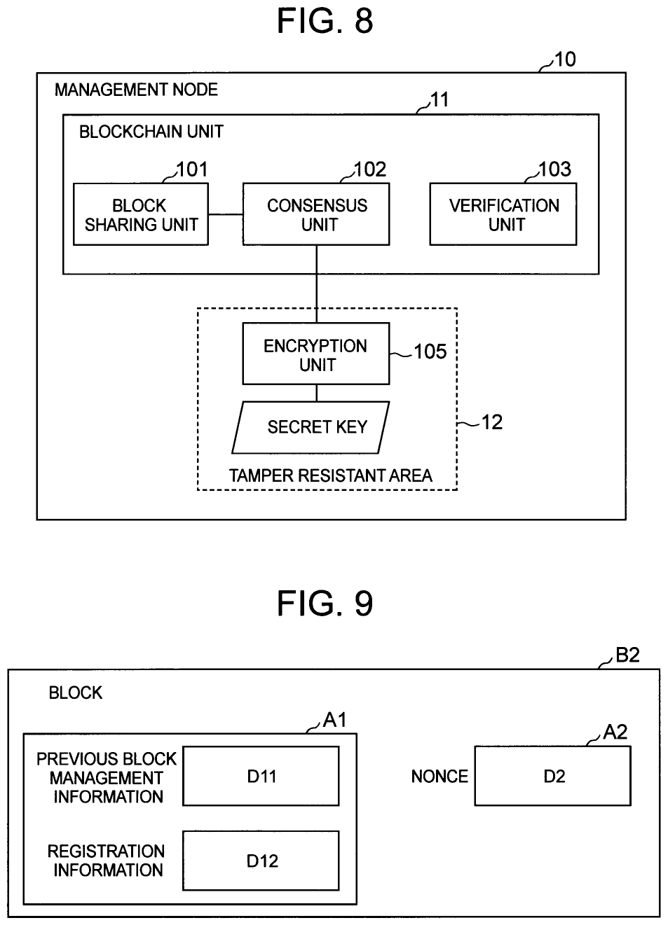

FIG. 8 is a block diagram showing another configuration example of the management node of the present exemplary embodiment. As shown in FIG. 8, the management node 10 may include an encryption unit 105 instead of the signature unit 104.

Note that, the encryption unit 105 of this example is placed in the tamper resistant area 12 isolated from the other process areas, and performs encryption on the input data in the tamper resistant area 12. An encryption method is not particularly limited, as long as conversion processing using a secret key is performed on designated data, and as a result, data can be generated that can only be decrypted with a public key paired with the secret key.

The consensus unit 102 of this example is only required to cause the encryption unit 105 to perform encryption on an encryption target area A6 instead of signature attaching operation performed by the signature unit 104. Here, the encryption target area A6 is an area to be encrypted in the block, and is similar to the above signature target area A4.

In addition, the verification unit 103 of this example is only required to perform verification by decryption using the public key of the generator of the block on an encrypted data area A6′, instead of verification operation based on the signature. Here, the encrypted data area A6′ is an area in which encrypted data encrypted by the encryption unit 105 is set, and is included in the block (encrypted block) after the encryption instead of the above encryption target area A6.

FIG. 9 is an explanatory diagram showing an example of the data structure of the block of this example. As shown in FIG. 9, as compared to the block B1 of a case where signature is used, the block B2 that is a block of a case where encryption is used instead of signature is different in that the signature area A3 is omitted. Note that, the data structure shown in FIG. 9 is a data structure before encryption of the block. Hereinafter, a block before encryption may be referred to as a plaintext block, and a block after encryption may be referred to as an encrypted block.

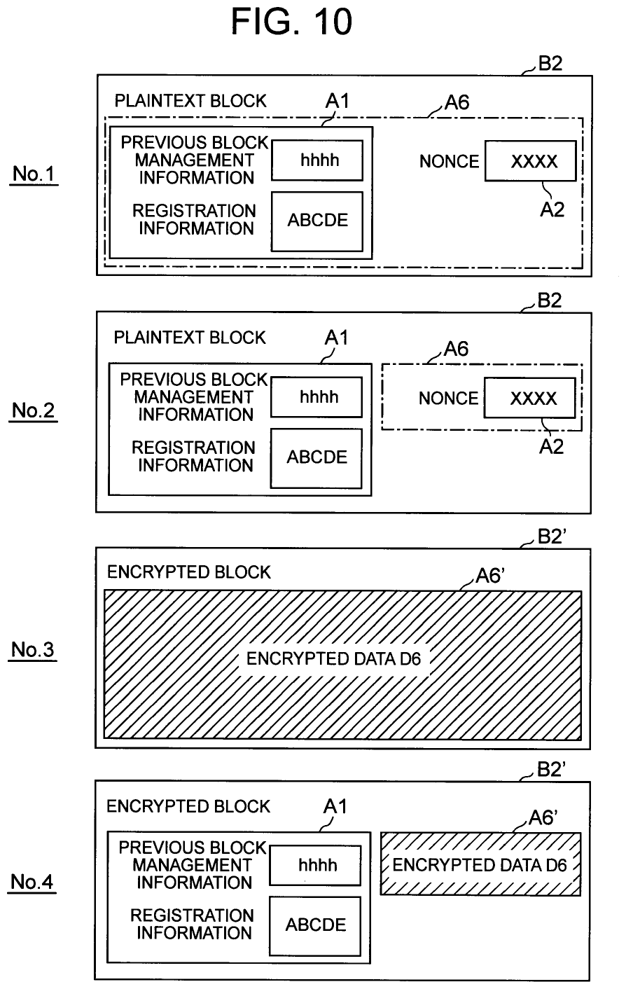

FIG. 10 is an explanatory diagram showing an example of the encryption target area A6 and the encrypted data area A6′ in the block of this example. Note that, No. 1 and No. 2 of FIG. 10 each are an example of a plaintext block B2, and No. 3 and No. 4 of FIG. 10 each are an example of an encrypted block B2′. Note that, after encryption of the plaintext block No. 1 of FIG. 10 corresponds to the encrypted block No. 3 of FIG. 10, and after encryption of the plaintext block No. 2 of FIG. 10 corresponds to the encrypted block No. 4 of FIG. 10.

As shown in No. 1 and No. 2 of FIG. 10, in the plaintext block, the encryption target area A6 is only required to include at least the nonce area A2.

In the encrypted data area A6′ in the encrypted block, encrypted data D6 is therefore set generated from data including at least nonce set in the nonce area A2. Then, the encrypted data area A6′ is provided instead of the data area in which original data (plaintext) of the encrypted data D6 is set in the plaintext block B2 before encryption. Note that, in this example, it is the encrypted block B2′ that is registered in the blockchain, and to be verified.

Note that, regarding the encryption target area A6, in a case where data is not attached from which it is seen that generated encrypted data has been subjected to encryption processing in the encryption processing, the following problem may occur. That is, when only a nonce is encrypted, there is a possibility that it cannot be determined whether the nonce obtained by decrypting the encrypted data in decryption processing has obtained the encryption processing.

In such a case, it is preferable that the data to be encrypted include information such as previous block management information by which correctness of decrypted data can be verified without the decryption processing. For example, the data area A1 may be included in the encryption target area A6. By doing so, by the fact that the previous block management information obtained by decryption matches the hash value computed from the actual previous block, it is possible to confirm that the encrypted data D6 is data that has obtained the encryption processing.

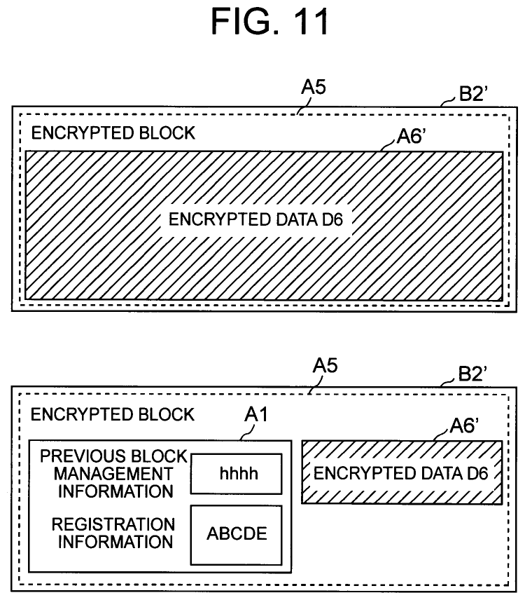

In addition, FIG. 11 is an explanatory diagram showing an example of the rule target area A5 in the encrypted block of this example. As shown in FIG. 11, the rule target area A5 is basically the entire block, similarly to the case of the configuration including the signature unit 104. However, the block referred to here is an encrypted block. The encrypted block includes the encrypted data area A6′ and, if there is a data area excluded from the target of encryption when the encrypted data D6 is generated, the data area (hereinafter referred to as a non-encryption-target area). Note that, the top of FIG. 11 is an example in a case where there is no non-encryption-target area, and the bottom of FIG. 11 is an example in a case where the non-encryption-target area is the data area A1.

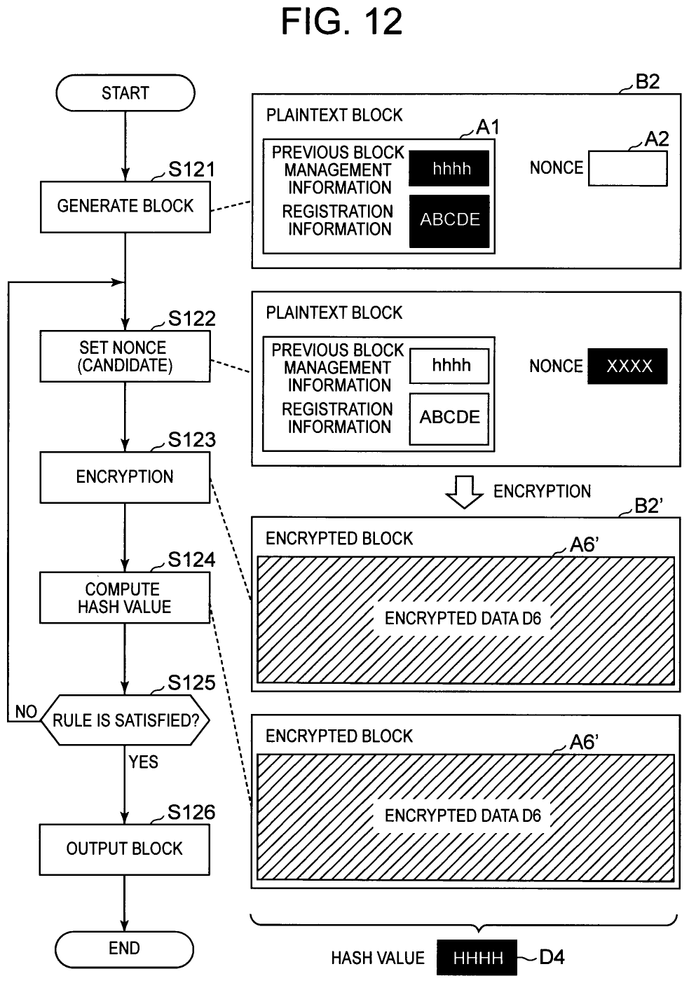

In addition, FIG. 12 is a flowchart showing an example of the verification information attaching operation of the management node 10 of this example. As shown in FIG. 12, the verification information attaching operation of this example is basically the same as the verification information attaching operation using a signature. However, “verification by decryption” is performed instead of “verification based on a signature”. Specifically, this example is different in that the signature attaching operation in step S103 in FIG. 4 is changed to encryption operation in step S123, and the hash value is computed for the encrypted block B2′ in step S124.

In the example shown in FIG. 12, first, the block sharing unit 101 generates a block (step S121). In this example, the block sharing unit 101 is only required to generate the plaintext block B2 in which the previous block management information D1l and the registration information D12 are set in the data area A1. Note that, the nonce area A2 is not set.

Next, the consensus unit 102 sets a nonce candidate in the nonce area A2 of the block generated in step S101 (step S122).

After step S122, the consensus unit 102 designates the data set in the encryption target area A6 of the generated block, and requests the encryption unit 105 to perform encryption. The encryption unit 105 performs encryption on the designated data on the basis of the request from the consensus unit 102 (step S123).

Upon receiving the encrypted data D6 generated by the encryption unit 105, the consensus unit 102 generates a new encrypted block B2′ including the encrypted data D6 and, if there is data set in the non-encryption-target area in the plaintext block B2, the data. Note that, the block setting example attached in step S123 in FIG. 11 is an example in a case where there is no non-encryption-target area. In this case, the encrypted block B2′ includes only the encrypted data D6. Note that, the encrypted data D6 of this example is encrypted data based on data as original data including the previous block management information D1l and registration information D12 stored in the data area A1, and the nonce (candidate) set in the nonce area A2.

When the encryption is ended, the consensus unit 102 computes the hash value D4 by using the data set in the rule target area A5 of the encrypted block B2′ (step S124).

The subsequent processing is similar to the verification information attaching operation using a signature. That is, setting and encryption of the nonce candidate are repeated until the process value satisfies the rule.

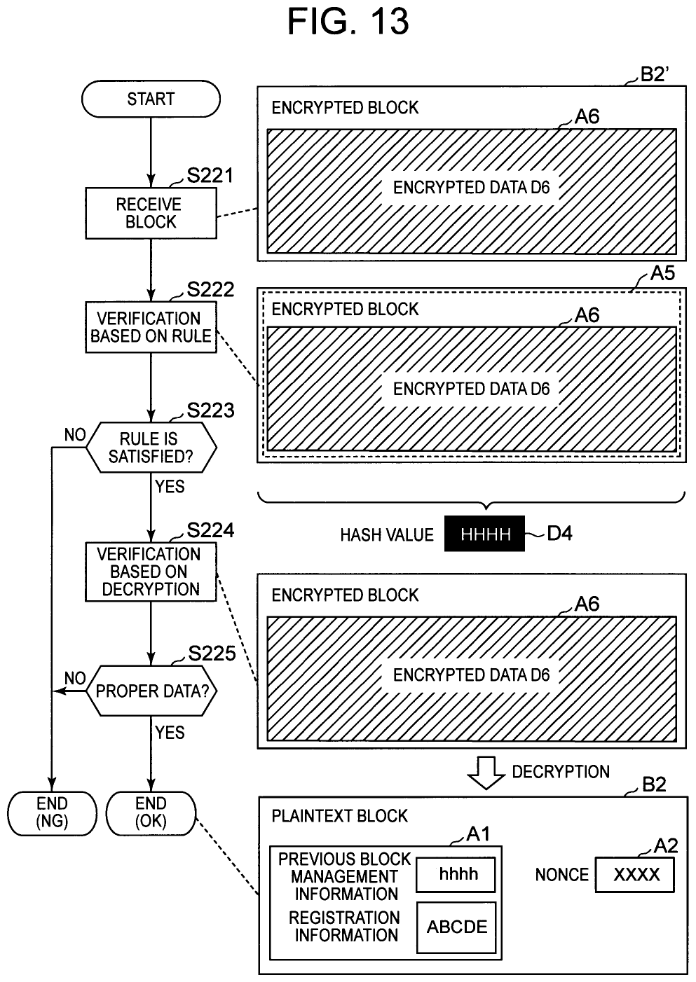

Next, the block verification operation of this example will be described. FIG. 13 is a flowchart showing an example of the block verification operation by the management node of this example. As shown in FIG. 13, the block verification operation of this example is basically the same as the block verification operation using a signature. However, “verification by decryption” is performed instead of “verification based on a signature”. Specifically, this example is different in that the verification operation based on the signature in step S204 in FIG. 7 is changed to verification operation by decryption in step S224, and the hash value is computed for the encrypted block in step S222.

In the example shown in FIG. 13, first, the block sharing unit 101 receives a block to be verified (step S221). In this example, the block sharing unit 101 receives the encrypted block B2′ in which it is determined that correct values are set in all the data areas.

Next, the verification unit 103 performs verification based on a rule on the block received in step S221 (step S222).

Note that, since the rule target area A4 includes the encrypted data area A6′ subjected to the encryption processing including the nonce area as the encryption target area, by the fact that the rule is satisfied, it is possible to confirm that the determination of the rule is performed after the encryption. That is, it is possible to confirm that the encrypted data D6 of the block is attached not after nonce search is completed, but at least before the nonce is found.

If the process value satisfies the rule as a result of the verification based on the rule (Yes in step S223), the verification unit 103 proceeds to step S224 to perform verification by decryption. On the other hand, if the process value does not satisfy the rule (No in step S223), it is determined that the block is not a proper block, and the processing is ended (end by NG determination).

In step S224, the verification unit 103 performs the verification by decryption on the encrypted data area A6′. More specifically, the verification unit 103 performs decryption on the encrypted data D6 set in the encrypted data area A6′ by using the public key of the generator of the block, and obtains decrypted data.

For example, in a case where the verification unit 103 can confirm that the obtained decrypted data is correct decrypted data, it is determined that the decrypted data is proper data (verification OK). On the other hand, in a case where it cannot be confirmed that the data is correct decrypted data, it is determined that the decrypted data is not the proper data (verification NG). Note that, a decryption method and a decrypted data verification method are not particularly limited, as long as they correspond to the encryption method performed by the encryption unit 105, and involve conversion processing using a public key paired with the secret key of the generator. Note that, it is preferable that the encryption method and the decryption method each are a method in which the correctness of the decrypted data can be determined only with the decrypted data and the encrypted data, but this is not necessarily so. In that case, the verification unit 103 is only required to determine the correctness of the decrypted data by further using the previous block management information as described above.

In the present invention, such operation of performing conversion processing on the encrypted data D6 set in the encrypted data area A6′ of the encrypted block B2′ by using the public key of the generator of the encrypted block and determining correctness of the decrypted data obtained from the encrypted data, is referred to as “verification by decryption”.

Since at least the nonce area A2 is included in the encryption target area A6 when the encrypted data D6 is obtained, by performing the verification by decryption, it is possible to confirm whether or not the encrypted data D6 is generated after setting of the nonce D2.

In the next step S225, if it is determined that the targeted data is proper data as a result of the verification by decryption (Yes in step S225), the verification unit 103 determines that the block is a proper block, and ends the processing (end by OK determination). On the other hand, in a case where it is determined that the block is not the proper data (No in step S225), it is determined that the block is not the proper block, and the processing is ended (end by NG determination).

As described above, by using both the verification based on the rule and the verification by decryption, it is possible to confirm that the encrypted data D6 of the block is attached not after nonce search is completed nor before the nonce search is started, but each time of the nonce search, and is set in accordance with a proper procedure. Note that, in the case of this example, the verification by decryption is performed after the verification based on the rule.

Note that, in the present exemplary embodiment, it is assumed that the signature target area A4, the rule target area A5, and the encryption area A6 are commonly defined in advance with a verification device (in this example, the verification unit 103 of each of the management nodes 10) that verifies the block B2.

As described above, in the present exemplary embodiment, the data structure of the block and verification operation are defined so that data process using the secret key of the management node 10 has to be performed in processing of PoW each time nonce search is performed, that is, each time a nonce candidate is set in the nonce area A2. For this reason, the computation resources of the external node not having the secret key cannot be used for nonce search. The falsification resistance can therefore be improved of a block and a blockchain to which the block is added.

### Second Exemplary Embodiment

Next, a second exemplary embodiment of the present invention will be described. In the first exemplary embodiment, each time a nonce candidate is set, data process using a secret key such as signature or encryption is performed to suppress use of external computation resources. However, in the method of the first exemplary embodiment, signature or encryption may be constantly performed in the tamper resistant area 12 until a nonce satisfying the rule is found, and there is a possibility that conflict with other processing occurs for use of the tamper resistant area 12.

Thus, in the present exemplary embodiment, one or a predetermined number of nonce areas are prepared in a block, and signature or encryption is performed each time PoW ends in a process in which a normal PoW (search for a nonce satisfying a rule) is performed on each of nonce areas. As a result, the number of times of data process in the tamper resistant area 12 is reduced.

However, this method allows a malicious management node to use external computation resources at PoW of each time. In the present exemplary embodiment, various parameters are therefore set so that an average required time for completing one PoW is a smaller value (or equivalent) to a round-trip propagation delay time+a with an external server. For example, a system administrator may perform control such as setting a rule that can relatively reduce an average required time for nonce setting of a proper node, adjusting the number of management nodes, or adjusting a communication speed of a network with an external server by a network configuration (such as wired configuration) or a firewall so that the above condition is satisfied.

Since the system configuration and the configuration of the management node 10 of the present exemplary embodiment are similar to those of the first exemplary embodiment, different parts will be mainly described below.

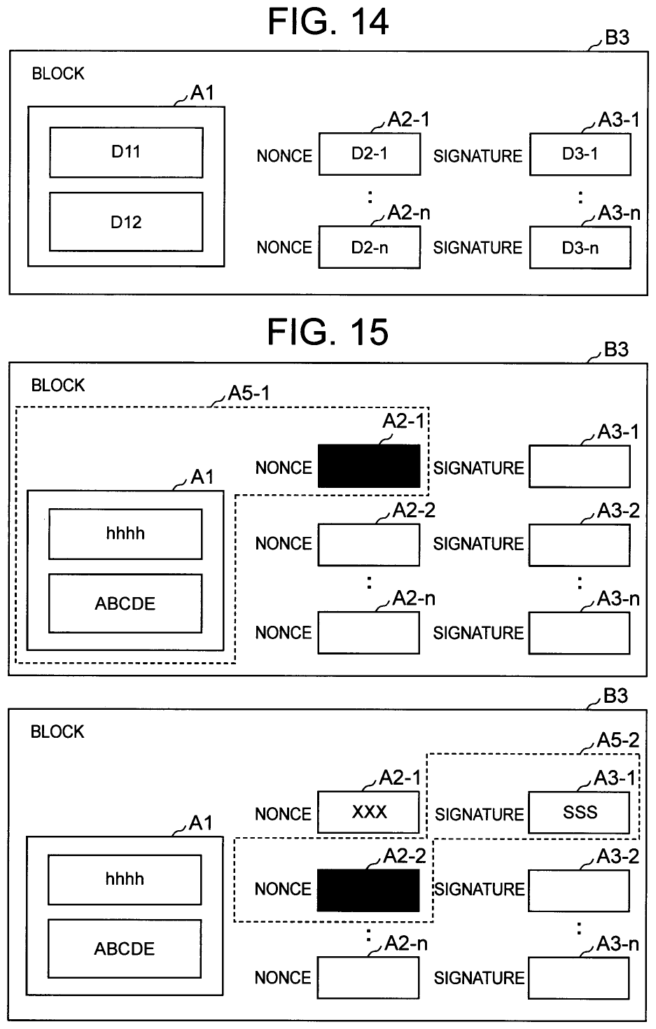

FIG. 14 is an explanatory diagram showing an example of the data structure of the block of the present exemplary embodiment. As shown in FIG. 14, a block B3 used in the present exemplary embodiment includes a predetermined number (n) of nonce areas A2 and signature areas A3, in addition to a data area A1. Note that, n may be 1. Hereinafter, hyphenated reference signs are used, such as A1-1 representing the first nonce area, and A3-1 representing the corresponding first signature area. Similarly, hyphenated reference signs are used, such as a nonce D2-1 representing a nonce set in the nonce area A1-1, and a signature D3-1 representing a signature set in a signature area A2-1. Note that, the same applies to other areas.

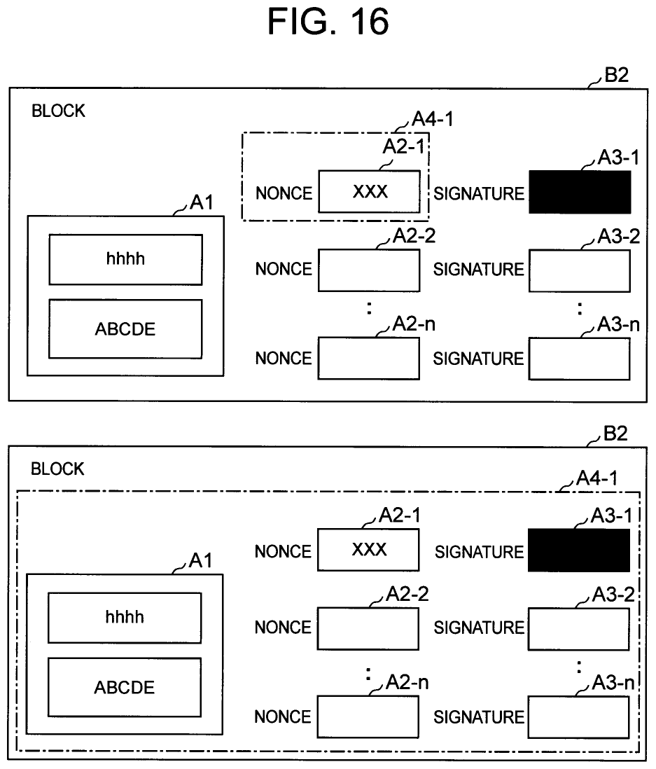

In addition, FIGS. 15 and 16 are explanatory diagrams showing examples of a rule target area A5-k of each time and a signature target area A4-k of each time in the block B3 of the present exemplary embodiment.

The top of FIG. 15 is an explanatory diagram showing an example of the rule target area A5-1 in the first PoW (nonce search and setting). As shown in the top of FIG. 15, the rule target area A5-1 in the first PoW includes at least the nonce area A2-1 of the corresponding time, and the data area A1.

In addition, the bottom of FIG. 15 is an explanatory diagram showing an example of the rule target area A5-2 in the second PoW. As shown in the bottom of FIG. 15, the rule target area A5-2 includes at least the nonce area A2-2 of the corresponding time, and the signature area A3-1 in which the immediately preceding signature is stored. Note that, the second and subsequent times are similar to the above. That is, the processing rule area A5-k (where 1<k<n) includes at least a nonce area A2-k in which the nonce of the concerned time is set, and a signature area A3-(k−1) in which the immediately preceding signature is stored.

Note that, as the rule target area A5 common to each time, the entire block at that point may be used each time.

In addition, the top of FIG. 16 and the bottom of FIG. 16 are explanatory diagrams each showing an example of the signature target area A4-1 after the first PoW in the block B3. The top of FIG. 16 is an example in which the signature target area A4-1 includes the nonce area A2-1. In addition, the bottom of FIG. 16 is an example in which the signature target area A4-1 is the entire block (in this example, the nonce area A2-1 and the data area A1 are included). Note that, the same applies to the other times, and the signature target area A4-k is only required to include at least the nonce area A2-k in which the nonce set immediately before is set.

Note that, as the signature target area A4 common to each time, the entire block at that point may be used each time.

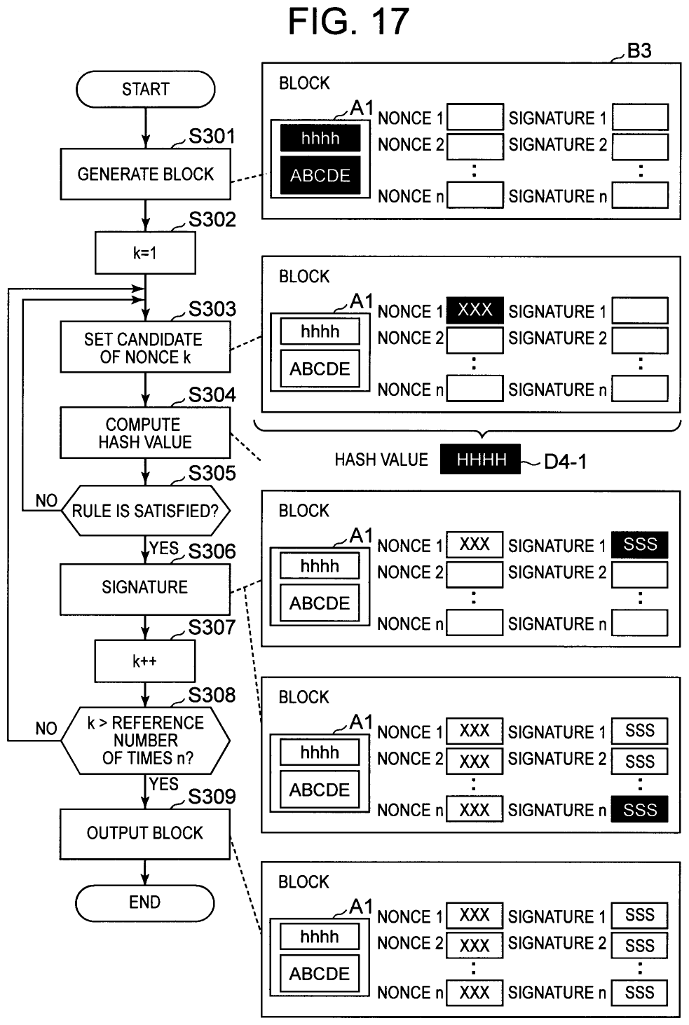

FIG. 17 is a flowchart showing an example of verification information attaching operation of the present exemplary embodiment. Note that, repeated processing of steps S303 to S305 shown in FIG. 17 corresponds to operation of a normal PoW. Also in this figure, a state is also shown of the block corresponding to each step of the flowchart.

In the example shown in FIG. 17, first, in step S301, the block sharing unit 101 generates the block B3 in which the previous block management information D11 and the registration information D12 are set in the data area A1. At this time, the block sharing unit 101 does not set all of the nonce areas A2-1 to A2-n and the signature areas A3-1 to A3-n.

Next, the consensus unit 102 performs the first PoW. The consensus unit 102 initializes k representing the number of times of processing of PoW to 1 (step S302), and repeats operations of steps S303 to S305.

First, the consensus unit 102 sets a nonce candidate in a nonce area D-k of the block B3 generated in step S101 (step S303).

Next, the consensus unit 102 computes a hash value D4-k by using the data set in the rule target area A5-k (step S304).

Next, the consensus unit 102 confirms whether or not the computed process value satisfies a predetermined rule (for example, whether it is less than or equal to a target threshold value) (step S305). In a case where the rule is satisfied, the current candidate is determined as a nonce D2-k, and the processing proceeds to step S306. On the other hand, in a case where the rule is not satisfied, the consensus unit 102 returns to step S303 and repeats the nonce setting process for the nonce area A2-k.

In step S306, the consensus unit 102 attaches a signature to the signature target area A4-k of the concerned time. Note that, a method of attaching a signature may a method similar to that of the first exemplary embodiment.

The signature generated here is set in the signature area A3-k. When the attaching of the signature is ended, the consensus unit 102 increments k by 1 (step S307). Then, the operations of steps S303 to S307 described above are repeated until k exceeds a reference number of times n (step S308).

When the operations of steps S303 to S307 described above are performed for the reference number of times n, the consensus unit 102 proceeds to step S309. In step S309, the consensus unit 102 outputs the finally obtained block B2 as a nonce-set block.

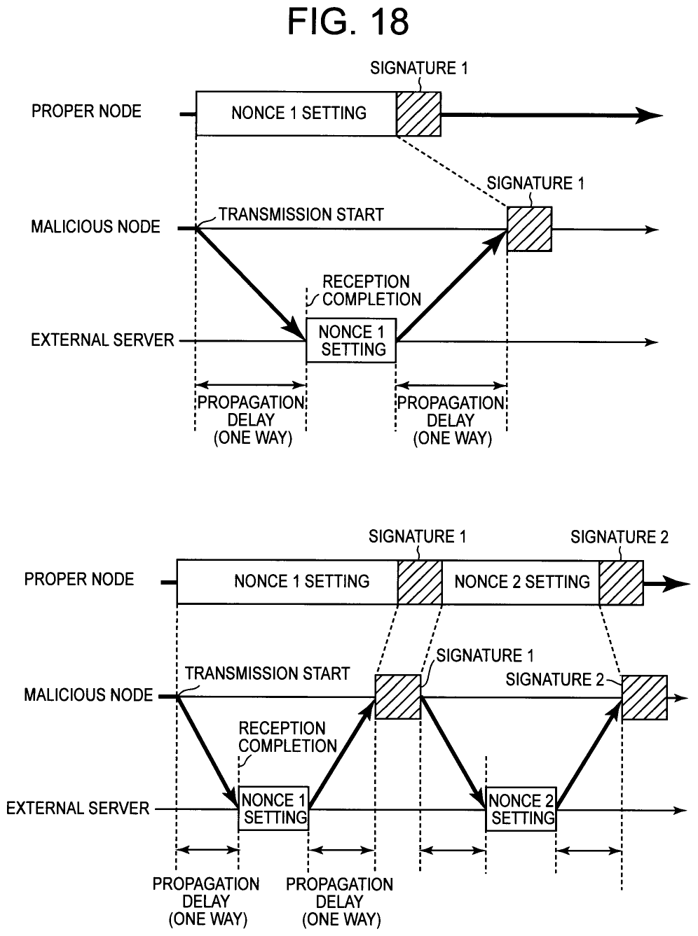

The top of FIG. 18 and the bottom of FIG. 18 are explanatory diagrams each showing a relationship between a required time for the verification information attaching operation according to the present exemplary embodiment and a required time in a case where an external server is used. The top of FIG. 18 is an example when n=1, comparing an outline and breakdown of a required time for the verification information attaching operation performed by the proper management node 10 (proper node in the figure) with an outline and breakdown of a required time in a case where a malicious node performs similar operation using the external server.

As shown in the top of FIG. 18, in the present exemplary embodiment, processing of searching for a nonce can be performed only by the external server. However, subsequent signature needs to be performed by a management node (malicious node) in the system. For this reason, the malicious node needs that the block is sent back after the external server finishes searching for the nonce. In addition to the operation of sending a block to cause the external server to search for a nonce, operation of transmitting and receiving the block occurs every time one nonce is set, between the malicious node and the external server.

Here, as shown in the top of FIG. 18, if a required time for nonce setting of one time by the proper node is a value smaller than a required time (including round-trip propagation delay time with the external server) in a case where the malicious node uses the external server, it is faster to perform processing with the malicious node alone, with high probability, so that the effect of using an external server is reduced.

Note that, the example shown in the bottom of FIG. 18 is an example when n=2 or more. Note that, since the required time for nonce setting in the proper node and the propagation delay time of the external network are not always fixed, designing is also possible to make the average required time for nonce search smaller than the average required time in a case where the malicious node uses the external server, by increasing the number of n.

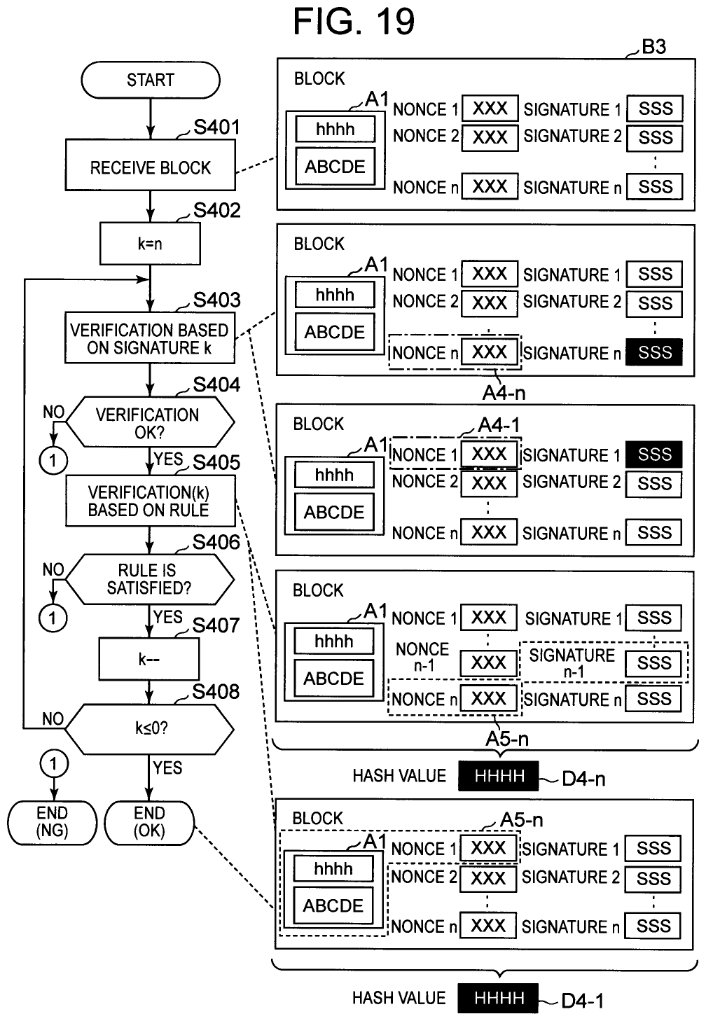

Next, block verification operation of the present exemplary embodiment will be described. FIG. 19 is a flowchart showing an example of the block verification operation by the management node of the present exemplary embodiment. Note that, also in this figure, a state is also shown of the block corresponding to each step of the flowchart.

In the example shown in FIG. 19, first, the block sharing unit 101 receives a block to be verified (step S401). In this example, the block sharing unit 101 receives the block B3 in which it is determined that correct values are set in all the data areas.

Next, the verification unit 103 performs verification process on PoW and subsequent signature of each time performed in the verification information attaching side in the reverse order of the order of PoW. The verification unit 103 initializes k representing a processing target of the verification process to n (step S402), and repeats operations of steps S403 to S408.

However, in a case where a result of verification NG is obtained on the way, the processing ends at that point.

The verification unit 103 first performs verification based on the signature D3-k on the signature target area A4-k in the block B3, as the verification process of each time (step S403).

Note that, the method of the verification based on the signature in each time may be a method similar to that of the first exemplary embodiment, except that the target area and the signature to be used are changed each time.

Since at least the nonce area A2-k is included in the signature target area A4-k, it is possible to confirm whether or not the signature D3-k is attached after setting of the nonce D2-k by performing the verification based on the signature.

In the next step S404, if it is determined that the targeted data is proper data as a result of the verification based on the signature (Yes in step S404), the verification unit 103 determines that the data as an attaching target of the signature corresponding to the concerned time is the proper data, and proceeds to step S405. On the other hand, in a case where it is determined that the data is not the proper data (No in step S404), it is determined that the data is not the proper data, and the processing is ended (end by NG determination).

In step S405, subsequently, the verification unit 103 performs verification based on a rule on the data set in the rule target area A4-k to confirm correctness of the nonce D2-k corresponding to the concerned time.

If k>1, since the rule target area A4-k includes the signature D3-(k−1) that is a result of signature attaching performed immediately before on the verification information attaching side, by the fact that the rule is satisfied, it is possible to confirm that determination of the rule of the concerned time is performed after attaching of the signature one time before the concerned time in the verification information attaching side. As a result, for example, in a case where the previous signature D3-(k−1) is correct, it is possible to confirm that the second and subsequent signature D3-k is attached after the previous nonce D2-(k−1) is attached. In addition, if k=1, it is possible to confirm that the determination of the rule is performed after the value is set in the data area A1.

If the process value does not satisfy the rule as a result of the verification based on the rule (No in step S405), the verification unit 103 regards the targeted data as improper data, and ends the processing (end by NG determination). On the other hand, if the process value satisfies the rule (Yes in step S405), the verification unit 103 regards the targeted data as proper data, and decrements k by 1. Then, the operations in steps S403 to S407 described above are repeated until k becomes 0 (that is, until the number of repetitions reaches the reference number of times n) (step S408).

Then, as a result of the determination in step S408, when all the times are ended, the block is determined as a proper block, and the processing is ended (end by the OK determination).

Note that, also in the present exemplary embodiment, the verification unit 103 may further perform verification based on the previous block management information before the end by OK determination.

As described above, the verification unit 103 verifies the operation in the verification attaching side in the reverse order of the order of PoW by using the signatures D3-1 to D3-n set in the block B3. As a result, it is possible to verify whether or not the block is generated in a proper procedure.

As described above, according to the present exemplary embodiment, the number of signatures in the tamper resistant area can be reduced, so that falsification resistance can be improved of the block and the blockchain to which the block is added while a free time of the tamper resistant area is secured.

### Third Exemplary Embodiment

Next, a third exemplary embodiment of the present invention will be described. In the second exemplary embodiment, as the number of repetitions (n) increases, the amount of data of the nonce D2 and the signature D3 in the block increases, and the overhead increases accordingly in block sharing and blockchain management.

Thus, in the present exemplary embodiment, the part in which signature is performed in the second exemplary embodiment is changed to encryption. Similarly, the part in which the verification based on the signature is performed is changed to verification by decryption.

Since the system configuration and the configuration of the management node 10 of the present exemplary embodiment are similar to those of the first and second exemplary embodiments, different parts will be mainly described below.

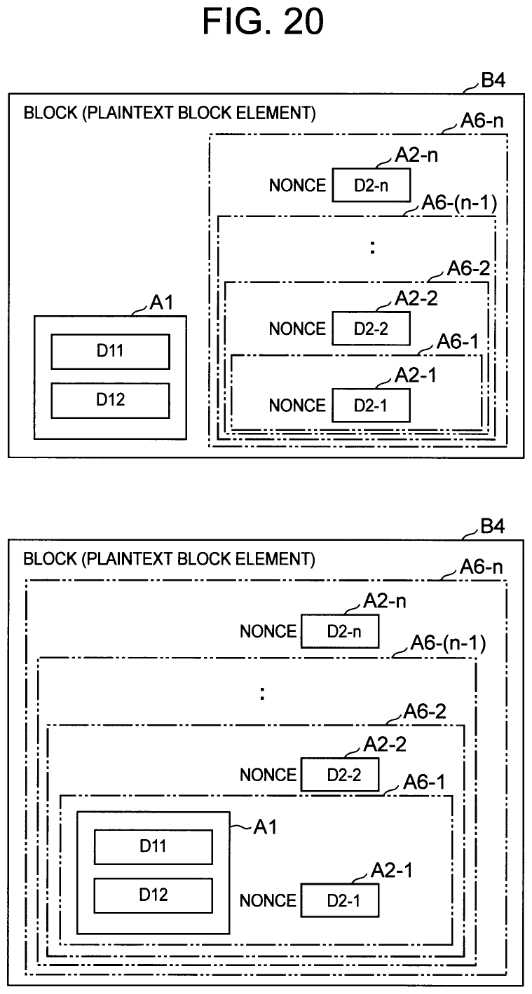

The top of FIG. 20 and the bottom of FIG. 20 are explanatory diagrams each showing an example of a data structure of a block of the present exemplary embodiment. Note that, the example shown in FIG. 20 shows data elements of a block B4 used in the present exemplary embodiment. In the example shown in FIG. 20, encryption target areas A6-1 to A6-n of respective times are represented in a nested structure.

As shown in the top of FIG. 20 and the bottom of FIG. 20, the block B4 of the present exemplary embodiment includes n encryption target areas A6-1 to A6-n in multiple layers, and each encryption target area A6-k includes at least a nonce area D2-k, and if there is an encrypted data area A6′-(k−1) in which data encrypted by the immediately preceding encryption area A6-(k−1) is set, the encrypted data area A6′-(k−1) (see the top of FIG. 20). Note that, each encryption target area A6-k may further include a data area A1 (see the bottom of FIG. 20).

Note that, the encryption target area A6-k has a structure in which one corresponding nonce area A2-k is added each time encryption is performed. That is, the nonce area A2 is newly secured separately from the previous nonce area A2 in repeated processing of each time.

In addition, in the following, in association with each of the k times of repeated processing, the block B4 before encryption may be referred to as a plaintext block B4-k, and the block B4 after encryption may be referred to as an encrypted block B4-k. Note that, the encrypted block B4-n corresponds to a block finally generated.

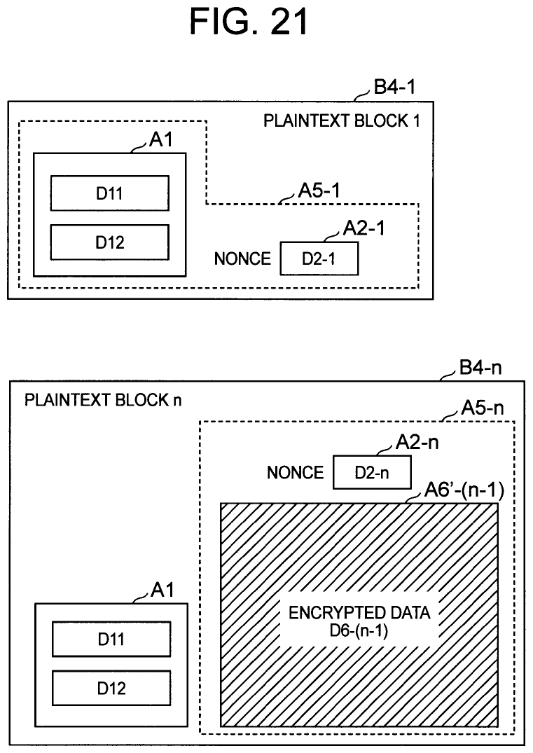

FIG. 21 is an explanatory diagram showing an example of the plaintext block B4-k.

The top of FIG. 21 is an explanatory diagram showing an example of the plaintext block B4-1, and the bottom of FIG. 21 is an explanatory diagram showing an example of the plaintext block B4-n. As shown in the top of FIG. 21, the plaintext block B4-1 input to the first PoW includes the data area A1 and the nonce area A2-1. In addition, the encryption target area A6-1 in the plaintext block B4-1 includes the data area A1 and the nonce area A2-1. In addition, as shown in the bottom of FIG. 21, the plaintext block B4-n input to the n-th PoW includes at least the encrypted data area A6′-(n−1) in which encrypted data obtained by the previous encryption is set, and the newly added nonce area A2-n. Note that, in the example shown in the bottom of FIG. 21, the plaintext block B4-n further includes the data area A1, but this is an example in a case where the data area A1 is not included in an encryption target of each time (case of the top of FIG. 20).

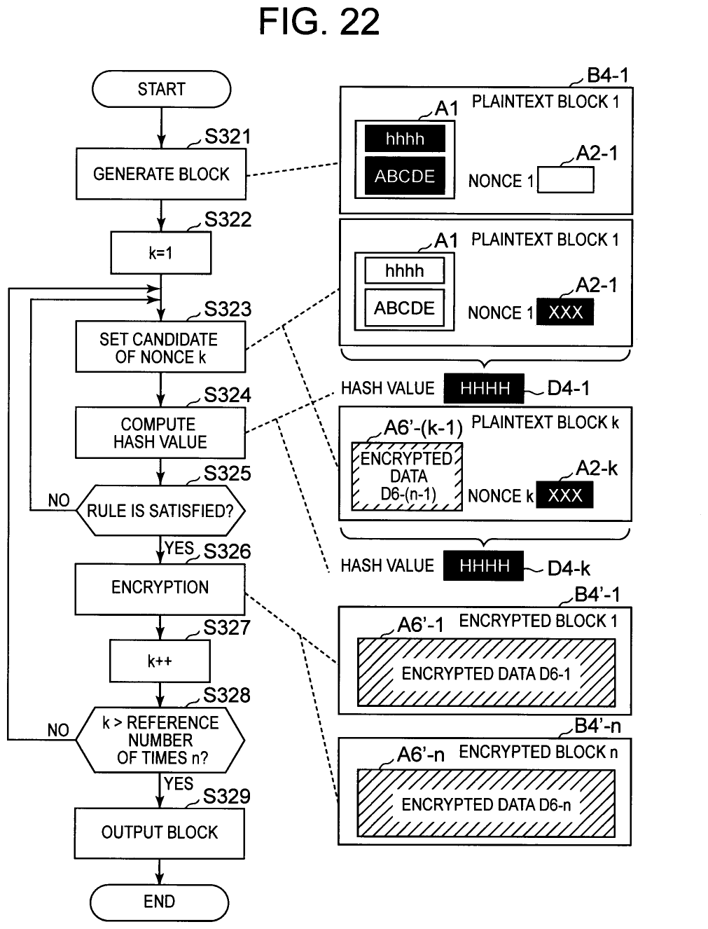

Next, operation of the present exemplary embodiment will be described. FIG. 22 is a flowchart showing an example of verification information attaching operation of the present exemplary embodiment. Note that, repeated processing of steps S323 to S325 shown in FIG. 22 corresponds to operation of a normal PoW. Also in this figure, a state is also shown of the block corresponding to each step of the flowchart.

In the example shown in FIG. 22, first, in step S321, the block sharing unit 101 generates the plaintext block B4-1 in which the previous block management information D1l and the registration information D12 are set in the data area A1. At this time, the block sharing unit 101 does not set the nonce area A2-1.

Next, the consensus unit 102 performs the first PoW. The consensus unit 102 initializes k representing the number of times of processing of PoW to 1 (step S322), and repeats operations of steps S323 to S325. Note that, the operations in steps S323 to S325 are similar to those in steps S303 to S305 in the second exemplary embodiment.

When the nonce D2-k satisfying a rule is found (Yes in step S325), in step S316, the consensus unit 102 performs encryption on the encryption target area A4-k of the plaintext block B4-k. Note that, the encryption method may be a method similar to that of the first exemplary embodiment.

The consensus unit 102 sets generated encrypted data D6-k in the encrypted data area A6′-k of an encrypted block B4′-k. Here, if there is a non-encryption-target area in the plaintext block B4-k, data of the area may also be set in the encrypted block B4′-k. Note that, the operation may be performed at the last encrypted block B4′-k.

When the setting of the encrypted data in the encrypted block is ended, the consensus unit 102 increments k by 1 (step S327). Then, the operations of steps S323 to S327 described above are repeated until k exceeds the reference number of times n (step S328). Note that, in the present exemplary embodiment, when returning to step S323, as a block as a setting target of a nonce, a plaintext block B4-k is passed to which the nonce area A2-k is further added to the encrypted block B4′-(k−1) including the encrypted data D6-(k−1) obtained in step S326. In this way, a result obtained each time is taken over to the next setting process.

Here, the reason for the encrypted data D6-(k−1) is that k is incremented by 1 in step S327, and it actually indicates the encrypted data obtained by the immediately preceding encryption. That is, when seen from the next nonce setting process, the consensus unit 102 is only required to input, as the next nonce setting target block, the plaintext block B4-k including at least the encrypted data D6-(k−1) generated from the previous plaintext block B4-(k−1) and the nonce area A2-k that is the current setting destination.

When the operations of steps S323 to S327 described above are performed for the reference number of times n, the consensus unit 102 proceeds to step S329 (Yes in step S328). In step S329, the consensus unit 102 outputs the final encrypted block B4′-n obtained at this point as a nonce-set block.

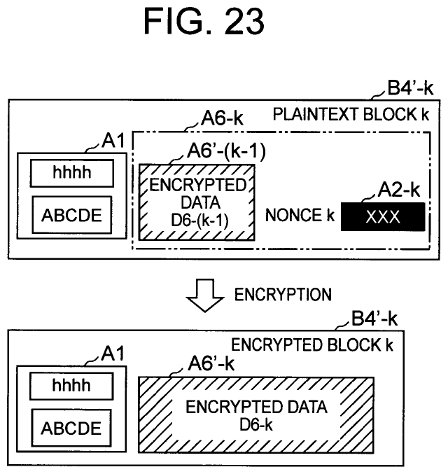

FIG. 23 is an explanatory diagram of another example of the encrypted block. For example, in step S324, the consensus unit 102 may perform encryption on the encryption target area A6-k including only the encrypted data area A6′-(k−1) in which the previous encrypted data D6-(k−1) is stored and the nonce area A2-k. In that case, the encrypted block B4′-k obtained after the encryption may include the data area A1 and the encrypted data area A6′-k.

Note that, as described above, reflection on the encrypted block of the data area A1 may be performed only once after the repeated processing is ended. In that case, although the data area A1 is treated as nonexistent in the second and subsequent nonce setting process, the data area A1 is included at least in the finally generated encrypted block B4′-n.

Note that, in the present exemplary embodiment, the encrypted data D6-n included in the finally generated encrypted block B4′-n functions as verification information including information for n nonces.

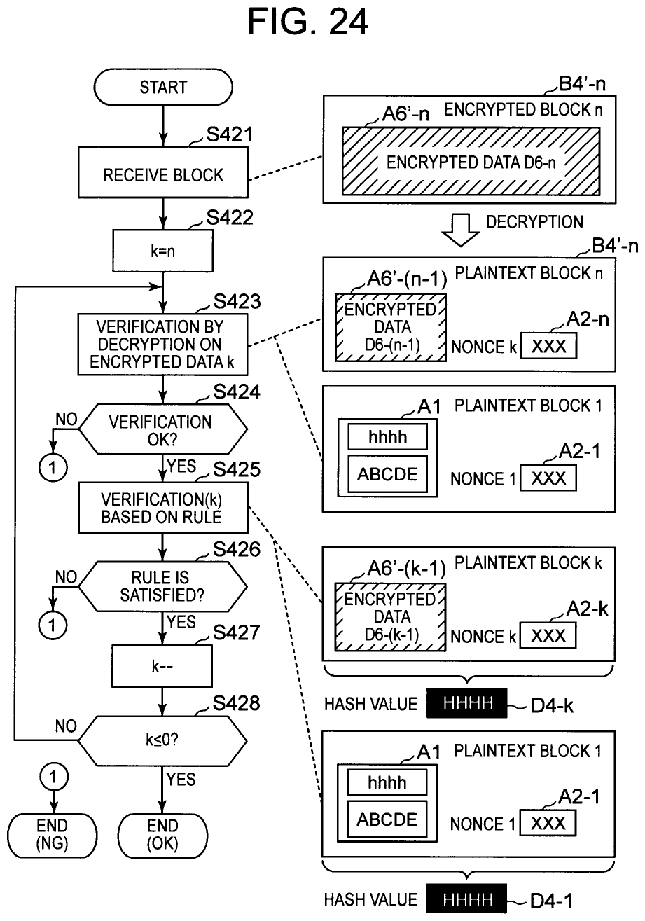

Next, block verification operation according to the present exemplary embodiment will be described. FIG. 24 is a flowchart showing an example of the block verification operation of the present exemplary embodiment. Note that, also in this figure, a state is also shown of the block corresponding to each step of the flowchart.

In the example shown in FIG. 24, first, the block sharing unit 101 receives a block to be verified (step S421). In this example, the block sharing unit 101 receives the encrypted block B4′-n in which it is determined that correct values are set in all the data areas.

Next, the verification unit 103 performs verification process on PoW and subsequent encryption of each time performed in the verification information attaching side in the reverse order of the order of PoW. The verification unit 103 initializes k representing a processing target of the verification process to n (step S422), and repeats operations of steps S423 to S428. However, in a case where a result of verification NG is obtained on the way, the processing ends at that point.

The verification unit 103 first performs verification by decryption on the encrypted data D6-k stored in the encrypted data area A6′-k in the encrypted block B4′-n, as the verification process of each time (step S423). Note that, the method of verification by decryption in each time may be a method similar to that of the first exemplary embodiment, except that the targeted encrypted data is changed each time.

Since the encryption target area A6-k when the encrypted data D6-k is generated includes, if k>1, the nonce area A2-k corresponding to the concerned time, and the immediately preceding encrypted data D6-(k−1), by performing verification by the decryption, it is possible to confirm whether or not the encryption of the concerned time is performed after the previous encryption and after setting of the nonce of the concerned time.

In the next step S424, if it is determined that the targeted data is proper data as a result of verification by the decryption (Yes in step S424), the verification unit 103 determines that the source data of the encrypted data corresponding to the concerned time is the proper data, and proceeds to step S425. On the other hand, in a case where it is determined that the data is not the proper data (No in step S424), it is determined that the data is not proper data, and the processing is ended (end by NG determination).

In step S425, subsequently, the verification unit 103 performs verification based on a rule on the data set in the rule target area A4-k of the plaintext block B4-k obtained by decryption to confirm correctness of the nonce D2-k corresponding to the concerned time.

Note that, if k>1, since the rule target area A4-k includes the encrypted data D6-(k−1) that is a result of the encryption performed immediately before in the verification information attaching side and is desired to secure the correctness by the nonce, by the fact that the rule is satisfied, it is possible to confirm that determination of the rule of the concerned time is performed after the encryption one time before the concerned time in the verification information attaching side. As a result, for example, in a case where the previous encrypted data D6-(k−1) is correct, it is possible to confirm that the second and subsequent encrypted data D6-k is attached after the previous nonce D2-(k−1) is attached. In addition, if k=1, it is possible to confirm that the determination of the rule is performed after the value is set in the data area A1.

If the process value does not satisfy the rule as a result of the verification based on the rule (No in step S425), the verification unit 103 regards the targeted data as improper data, and ends the processing (end by NG determination). On the other hand, if the process value satisfies the rule (Yes in step S425), the verification unit 103 regards the targeted data as proper data, and decrements k by 1. Then, the operations in steps S423 to S427 described above are repeated until k becomes 0 (that is, until the number of repetitions reaches the reference number of times n) (step S428).

Note that, in the present exemplary embodiment, when returning to step S423, as a block to be verified, the plaintext block B4-(k−1) obtained by the decryption in step S423 or the encrypted data D6-(k−2) included in the block may be passed. In this way, a result obtained each time is taken over to the next verification process.

Here, the reason for the plaintext block B4-(k−1) and the encrypted data D6-(k−2) is that k is incremented by 1 in step S427, and both actually indicate the data obtained by the immediately preceding decryption. That is, when seen from the next verification process, the consensus unit 102 may input, as the next verification target block, the encrypted block B4′-k including at least the encrypted data D6′-(k−1) included in the decrypted data obtained from the previous encrypted block B4′-(k−1).

When the operations of steps S423 to S427 described above are performed for the reference number of times n, the consensus unit 102 proceeds to step S429 (Yes in step S428). In step S429, the consensus unit 102 outputs the final plaintext block B4-1 obtained at this point as a verified block (proper block), and ends the processing (end by OK determination).

Note that, also in the present exemplary embodiment, the verification unit 103 may further perform verification based on the previous block management information before the end by OK determination.

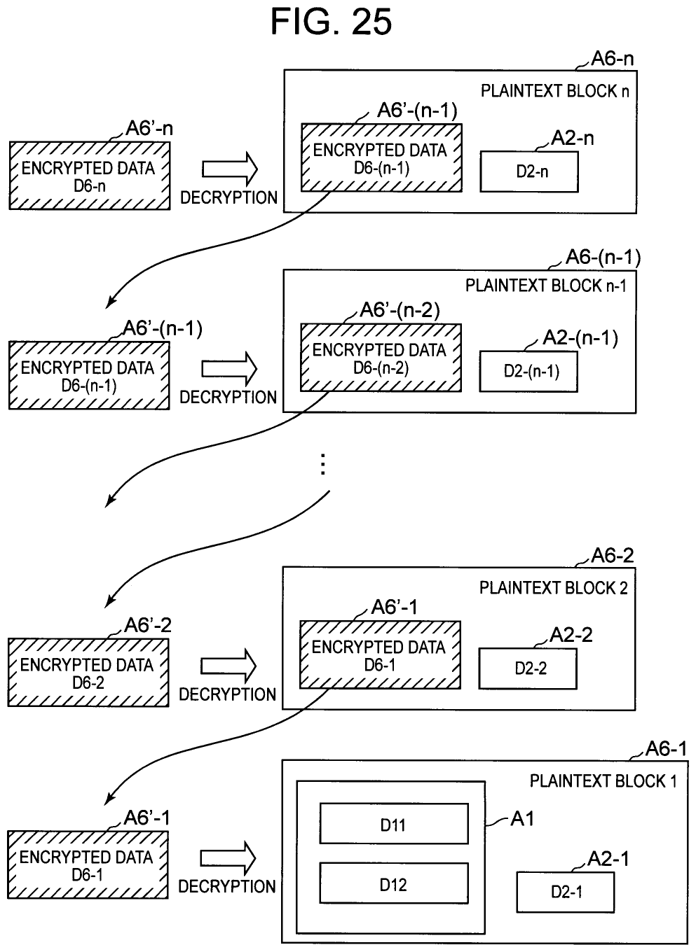

In addition, FIG. 25 is an explanatory diagram showing a state of decryption of the encrypted data D6-n of a hierarchical structure performed by repetition of the verification process of the present exemplary embodiment. As shown in FIG. 25, starting from the encrypted data D6-n, the encrypted data included in the decrypted data obtained by decryption of each time is set as the next decryption target, and the plaintext block B4-1 initially generated in the verification attaching side can be finally obtained through n times of decryption. Note that, verification operation for a plaintext block B-1 is the same as verification operation in a normal PoW.

As described above, according to the present exemplary embodiment, in addition to the effect of the second exemplary embodiment, it can be expected not only that the amount of data increases by the amount of the nonce area even if the number of repetitions increases but also further compression of the data by encryption.

Note that, in the above description, although the signature unit 104 and the encryption unit 105 are described as being held in the tamper resistant area 12, on the assumption that the secret key is not leaked to the outside, the signature unit 104 and the encryption unit 105 may perform signature and encryption in a process area that does not have tamper resistance (it does not matter whether or not the process area is isolated from other process areas). Note that, in consideration of infection with malware or the like, it is more preferable that the signature unit 104 and the encryption unit 105 are held in a process area isolated from other process areas, and performs signature and encryption in the process area. Note that, it is further preferable that the process area has tamper resistance.

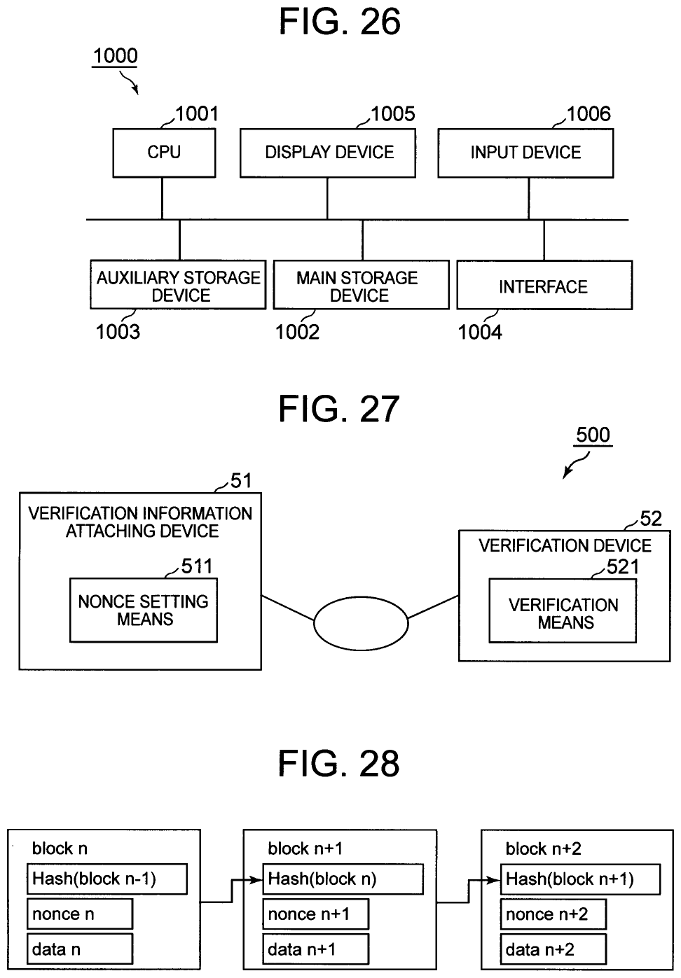

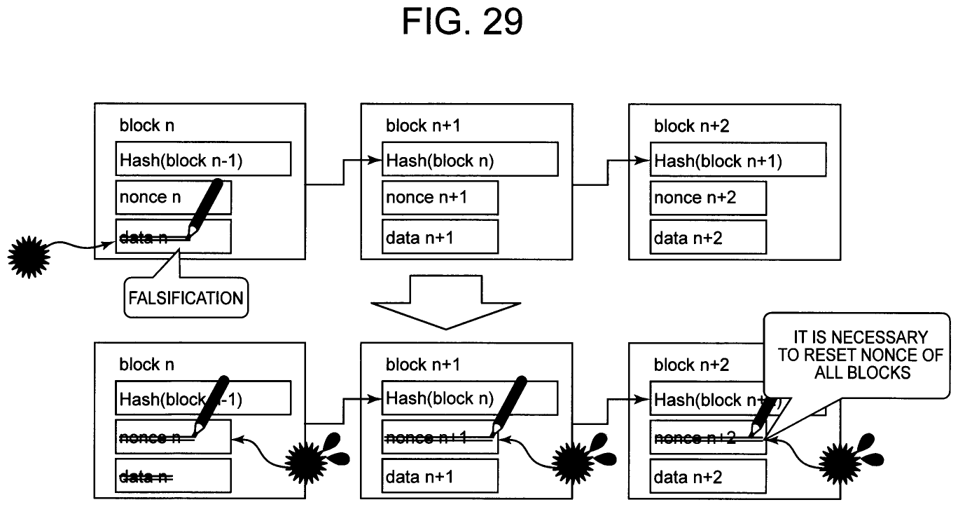

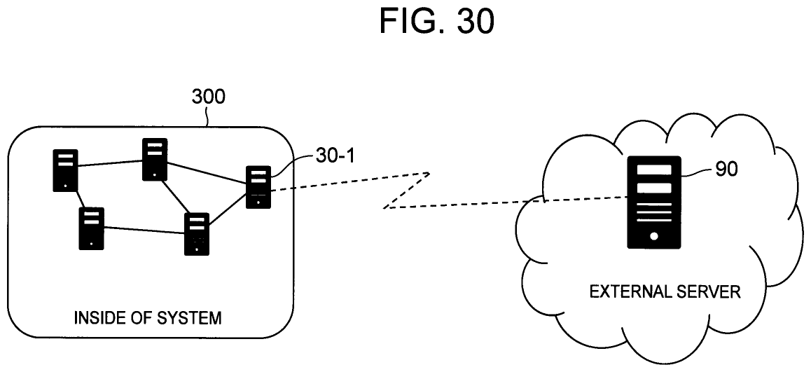

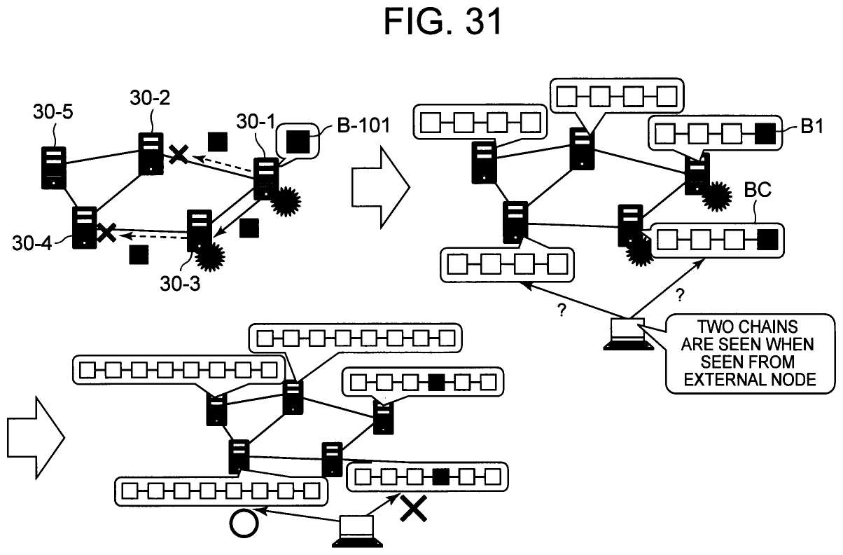

Next, a configuration example will be described of a computer according to the exemplary embodiments of the present invention. FIG. 26 is a schematic block diagram showing a configuration example of the computer according to the exemplary embodiments of the present invention. A computer 1000 includes a CPU1001, a main storage device 1002, an auxiliary storage device 1003, an interface 1004, a display device 1005, and an input device 1006.

The management node described above, the verification information attaching device 51 and the verification device 52 described later may be mounted on the computer 1000, for example. In that case, operation of each device may be stored in the auxiliary storage device 1003 in the form of a program. The CPU 1001 reads the program from the auxiliary storage device 1003, and deploys the program on the main storage device 1002, and then implements predetermined processing in the exemplary embodiments described above in accordance with the program.

The auxiliary storage device 1003 is an example of a non-transitory tangible medium.

Other examples of the non-transitory tangible medium include a semiconductor memory, DVD-ROM, CD-ROM, a magneto-optical disk, and a magnetic disk connected via the interface 1004. In addition, in a case where the program is delivered to the computer 1000 via a communication line, the computer 1000 to which the program is delivered may deploy the program on the main storage device 1002 to execute the predetermined processing in the exemplary embodiments described above.

In addition, the program may be for realizing a part of predetermined processing in each exemplary embodiment. Further, the program may be a differential program that realizes the predetermined processing in the exemplary embodiments described above in combination with another program already stored in the auxiliary storage device 1003.

The interface 1004 exchanges information with other devices. In addition, the display device 1005 presents information to a user. In addition, the input device 1006 receives input of information from the user.

In addition, depending on processing contents in the exemplary embodiment, some elements of the computer 1000 can be omitted. For example, if the device does not present information to the user, the display device 1005 can be omitted.

In addition, some or all of the constituent elements of each device are implemented by general purpose or dedicated circuitry, a processor, or the like, or a combination thereof. These may be configured by a single chip or may be configured by a plurality of chips connected together via a bus. In addition, some or all of the constituent elements of each device may be realized by a combination of the program and the circuitry and the like described above.

In a case where some or all of the constituent elements of each device are realized by a plurality of information processing devices, the circuitry, and the like, the plurality of information processing devices, the circuitry, and the like may be centrally arranged, or may be distributedly arranged. For example, the information processing device, the circuitry, and the like may be realized by being connected together via a communication network, such as a client and server system and a cloud computing system.

Next, an outline of the present invention will be described. FIG. 27 is a block diagram showing an outline of an information verification system of the present invention. An information management system 500 shown in FIG. 27 includes a verification information attaching device 51 and a verification device 52.

The verification information attaching device 51 includes a nonce setting means 511.

The nonce setting means 511 (for example, the consensus unit 102) performs a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set, and performing a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process.

The verification device 52 includes a verification means 521.

The verification means 521 (for example, the verification unit 103) verifies a second data block that is a data block of a predetermined data structure that includes process data that is data obtained as a result of data process, the process data output from the verification information attaching device 51. More specifically, the verification means 521 verifies the second data block by performing first verification process of verifying the process data included in the second data block by using a public key of the verification information attaching device that is a generation source of the second data block, and second verification process of verifying the second data block or data based on the second data block on a basis of the rule.

Note that, the above exemplary embodiments can be described also as the following supplementary notes.

(Supplementary Note 1)

A verification information attaching device including:

a nonce setting means that performs a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set, in which

the nonce setting means performs a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process.

(Supplementary Note 2)

The verification information attaching device according to supplementary note 1, in which

the nonce setting means performs the data process in a process area isolated from another process area.

(Supplementary Note 3)

The verification information attaching device according to supplementary note 1 or 2, in which

the nonce setting means performs the data process in a tamper resistant area in which the secret key is not taken out externally.

(Supplementary Note 4)

The verification information attaching device according to any one of supplementary notes 1 to 3, in which

the nonce setting means outputs a data block of a predetermined data structure that includes process data that is data obtained as a result of the data process, as a result of performing the setting process.

(Supplementary Note 5)

The verification information attaching device according to any one of supplementary notes 1 to 4, in which

the nonce setting means performs signature or encryption, in which the secret key of the verification information attaching device is used, on the predetermined data area of the first data block that includes the nonce area each time a value is set to the nonce area in the setting process,

the nonce setting means determines whether or not the process value satisfies the rule, the process value obtained from the first data block to which the signature is attached in the setting process, or new first data block that includes encrypted data obtained by the encryption instead of data as a target of the encryption, and

the nonce setting means outputs a data block in which the process value is obtained in a case where the process value satisfies the rule.

(Supplementary Note 6)

The verification information attaching device according to supplementary note 5, in which

the first data block includes a first data area in which arbitrary data is stored, and a header area in which information is set based on a data block added as a block one or more blocks before the first data block in a predetermined blockchain formed by connecting a plurality of data blocks, and

the nonce setting means performs encryption, in which the secret key of the verification information attaching device is used, on a predetermined data area of the first data block that includes the nonce area and the header area each time a value is set to the nonce area in the setting process.

(Supplementary Note 7)

The verification information attaching device according to any one of supplementary notes 1 to 4, in which

the nonce setting means performs the setting process once or a predetermined number of times, and for a second and subsequent times, performs the setting process while taking over data obtained so far to the first data block and changing or adding a nonce area of a setting destination,

the nonce setting means performs signature or encryption, in which the secret key of the verification information attaching device is used, on a predetermined data area of the first data block that at least includes a nonce area in which the nonce is set each time the nonce that satisfies the rule is set to one of the nonce areas by the setting process, and

the nonce setting means outputs the first data block after attaching of a last signature, or a data block that at least includes encrypted data obtained by last encryption.

(Supplementary Note 8)

The verification information attaching device according to any one of supplementary notes 1 to 4, in which

the nonce setting means repeatedly performs the setting process once or a predetermined number of times while designating one nonce area as a setting destination on the first data block that includes one or a predetermined number of nonce areas,

the nonce setting means performs signature, in which the secret key of the verification information attaching device is used, on a signature target area that is a predetermined data area of the first data block that includes the nonce area in which the nonce is set each time the nonce that satisfies the rule is set to the designated nonce area by the setting process,

the nonce setting means determines whether or not the process value satisfies the rule, the process value obtained from data of a rule target area that is a predetermined data area of the first data block that at least includes the nonce area and an area to which a signature attached immediately before is set, while setting a value in the designated nonce area in each setting process, and

the nonce setting means outputs the first data block to which the predetermined number of signatures are attached as a result of performing the setting process for the predetermined number of times.

(Supplementary Note 9)

The verification information attaching device according to supplementary note 8, in which

an average required time for setting process of one time, or the rule is determined on a basis of a propagation delay time with the external node.

(Supplementary Note 10)

The verification information attaching device according to any one of supplementary notes 1 to 4, in which

the nonce setting means repeatedly performs the setting process once or a predetermined number of times on the first data block that includes a first data area in which arbitrary data is stored while sequentially adding a nonce area to be set as a nonce setting destination,

the nonce setting means performs encryption, in which the secret key of the verification information attaching device is used, on an encryption target area that is a predetermined data area of the first data block that includes the nonce area each time a nonce that satisfies the rule is set to the nonce area as the setting destination by the setting process,

the nonce setting means sets a nonce in the nonce area such that the process value satisfies the rule, the process value obtained from the first data block that includes the nonce area set as the setting destination and the first data area, in first setting process,

the nonce setting means sets a nonce in the nonce area such that the process value obtained from the first data block satisfies the rule, for a new first data block that at least includes the nonce area set as the setting destination and an encrypted data area in which encrypted data obtained by immediately preceding encryption, in second and subsequent setting process, and

the nonce setting means outputs a data block that at least includes encrypted data obtained by last encryption as a result of performing the setting process for the predetermined number of times.

(Supplementary Note 11)

A verification device that verifies a second data block that is a data block of a predetermined data structure that includes process data that is data obtained as a result of predetermined data process, the process data output from a verification information attaching device that includes a nonce setting means that performs a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set, wherein the nonce setting means performs a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process,

the verification device comprising

a verification means that performs first verification process of verifying the process data included in the second data block by using a public key of the verification information attaching device that is a generation source of the second data block, and second verification process of verifying the second data block or data based on the second data block on a basis of the rule.

(Supplementary Note 12)

The verification device according to supplementary note 11, in which

the verification device verifies the second data block that is the data block output from the verification information attaching device that includes the nonce setting means that performs signature or encryption, in which the secret key of the verification information attaching device is used, on the predetermined data area of the first data block that includes the nonce area each time a value is set to the nonce area in the setting process, determines whether or not the process value satisfies the rule, the process value obtained from the first data block to which the signature is attached in the setting process, or new first data block that includes encrypted data obtained by the encryption instead of data as a target of the encryption, and outputs a data block in which the process value is obtained in a case where the process value satisfies the rule, and

the verification means verifies the signature and target data that is data as an attaching target of the signature included in the second data block, or the encrypted data, by using the public key, in the first verification process, and verifies whether or not the process value obtained from the second data block satisfies the rule, for the second data block that is the first data block to which the signature is attached, or new second data block that includes original data obtained by decrypting the encrypted data instead of the encrypted data, in the second verification process.

(Supplementary Note 13)

The verification device according to supplementary note 11, in which

the verification device verifies the second data block that is the data block output from the verification information attaching device that includes the nonce setting means that repeatedly performs the setting process once or a predetermined number of times while designating one nonce area as a setting destination on the first data block that includes one or a predetermined number of nonce areas, performs signature, in which the secret key of the verification information attaching device is used, on a signature target area that is a predetermined data area of the first data block that includes the nonce area in which the nonce is set each time the nonce that satisfies the rule is set to the designated nonce area by the setting process, determines whether or not the process value satisfies the rule, the process value obtained from data of a rule target area that is a predetermined data area of the first data block that at least includes the nonce area and an area to which a signature attached immediately before is set, while setting a value in the designated nonce area in each setting process, and outputs the first data block to which the predetermined number of signatures are attached as a result of performing the setting process for the predetermined number of times,

the verification means repeatedly performs the first verification process and the second verification process in this order the predetermined number of times while designating one of the signatures included in the second data block in reverse order of attached order, and

the verification means verifies the designated signature included in the second data block, and target data that is data of the signature target area as an attaching target of the signature, by using the public key, in the first verification process of each time, and verifies whether or not the process value satisfies the rule, the process value obtained from data of the rule target area that includes the area in which the signature verified in the immediately preceding first verification process is set, in the second verification process of each time.

(Supplementary Note 14)

The verification device according to supplementary note 11, in which

the verification device verifies the second data block that is the data block output from the verification information attaching device that includes the nonce setting means that repeatedly performs the setting process once or a predetermined number of times on the first data block that includes a first data area in which arbitrary data is stored while sequentially adding a nonce area to be set as a nonce setting destination, performs encryption, in which the secret key of the verification information attaching device is used, on an encryption target area that is a predetermined data area of the first data block that includes the nonce area each time a nonce that satisfies the rule is set to the nonce area as the setting destination by the setting process, sets a nonce in the nonce area such that the process value satisfies the rule, the process value obtained from the first data block that includes the nonce area set as the setting destination and the first data area, in first setting process, sets a nonce in the nonce area such that the process value obtained from the first data block satisfies the rule, for a new first data block that at least includes the nonce area set as the setting destination and an encrypted data area in which encrypted data obtained by immediately preceding encryption, in second and subsequent setting process, and outputs a data block that at least includes encrypted data obtained by last encryption as a result of performing the setting process for the predetermined number of times,

the verification means repeatedly performs the first verification process and the second verification process in this order the predetermined number of times,

the verification means decrypts encrypted data included in the second data block or new second data block obtained by the previous first verification process, by using the public key, and verifies a decryption result, and obtains new second data block that at least includes original data obtained by the decryption, in the first verification process of each time, and

the verification means verifies whether or not the process value obtained from the new second data block obtained by the immediately preceding first verification process satisfies the rule, in the second verification process of each time.

(Supplementary Note 15)

An information management system including

a verification information attaching device and a verification device, wherein

the verification information attaching device includes a nonce setting means that performs a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set,

the nonce setting means performs a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process, and

the verification device includes a verification means that performs, on a second data block that is a data block of a predetermined data structure that includes process data that is data obtained as a result of the predetermined data process output from the verification information attaching device, first verification process of verifying the process data included in the second data block by using a public key of the verification information attaching device that is a generation source of the second data block, and second verification process of verifying the second data block or data based on the second data block on a basis of the rule.

(Supplementary Note 16)

A verification information attaching method including:

performing a setting process once or a predetermined number of times, the setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set; and

performing a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process.

(Supplementary Note 17)

A verification information attaching program for causing

a computer to execute:

a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set; and

a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process.

In the above, the present invention has been described with reference to exemplary embodiments and examples; however, the present invention is not limited to the exemplary embodiments and examples described above. Various modifications that can be understood by those skilled in the art within the scope of the present invention can be made to the configuration and details of the present invention.

### INDUSTRIAL APPLICABILITY

The present invention is suitably applicable in an application where information is to be distributed and managed, in particular, in a case where a private blockchain is used. Note that, the present invention can be applied to a system if it is the one in which information is recorded on a shared ledger of a plurality of nodes through PoW even if it is other than the private blockchain.

### REFERENCE SIGNS LIST

100 Information management system
200 System network
10 Management node
10 Blockchain unit
11 Tamper resistant area
101 Block sharing unit
102 Consensus unit
103 Verification unit
104 Signature unit
105 Encryption unit
1000 Computer
1001 CPU
1002 Main storage device
1003 Auxiliary storage device
1004 Interface
1005 Display device
1006 Input device
500 Information management system
51 Verification information attaching device
511 Nonce setting means
52 Verification device
521 Verification means
90 External server
30 Node
300 Information management system

1. A verification information attaching device comprising:
a nonce setting unit that performs a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set, wherein
the nonce setting unit performs a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process.

2. The verification information attaching device according to claim 1, wherein
the nonce setting unit performs the data process in a process area isolated from another process area.

3. The verification information attaching device according to claim 1, wherein
the nonce setting unit performs the data process in a tamper resistant area in which the secret key is not taken out externally.

4. The verification information attaching device according to claim 1, wherein
the nonce setting unit outputs a data block of a predetermined data structure that includes process data that is data obtained as a result of the data process, as a result of performing the setting process.

5. The verification information attaching device according to claim 1, wherein
the nonce setting unit performs signature or encryption, in which the secret key of the verification information attaching device is used, on the predetermined data area of the first data block that includes the nonce area each time a value is set to the nonce area in the setting process,
the nonce setting unit determines whether or not the process value satisfies the rule, the process value obtained from the first data block to which the signature is attached in the setting process, or new first data block that includes encrypted data obtained by the encryption instead of data as a target of the encryption, and
the nonce setting unit outputs a data block in which the process value is obtained in a case where the process value satisfies the rule.

6. The verification information attaching device according to claim 5, wherein
the first data block includes a first data area in which arbitrary data is stored, and a header area in which information is set based on a data block added as a block one or more blocks before the first data block in a predetermined blockchain formed by connecting a plurality of data blocks, and
the nonce setting unit performs encryption, in which the secret key of the verification information attaching device is used, on a predetermined data area of the first data block that includes the nonce area and the header area each time a value is set to the nonce area in the setting process.

7. The verification information attaching device according to claim 1, wherein
the nonce setting unit performs the setting process once or a predetermined number of times, and for a second and subsequent times, performs the setting process while taking over data obtained so far to the first data block and changing or adding a nonce area of a setting destination,
the nonce setting unit performs signature or encryption, in which the secret key of the verification information attaching device is used, on a predetermined data area of the first data block that at least includes a nonce area in which the nonce is set each time the nonce that satisfies the rule is set to one of the nonce areas by the setting process, and
the nonce setting unit outputs the first data block after attaching of a last signature, or a data block that at least includes encrypted data obtained by last encryption.

8. The verification information attaching device according to claim 1, wherein
the nonce setting unit repeatedly performs the setting process once or a predetermined number of times while designating one nonce area as a setting destination on the first data block that includes one or a predetermined number of nonce areas,
the nonce setting unit performs signature, in which the secret key of the verification information attaching device is used, on a signature target area that is a predetermined data area of the first data block that includes the nonce area in which the nonce is set each time the nonce that satisfies the rule is set to the designated nonce area by the setting process,
the nonce setting unit determines whether or not the process value satisfies the rule, the process value obtained from data of a rule target area that is a predetermined data area of the first data block that at least includes the nonce area and an area to which a signature attached immediately before is set, while setting a value in the designated nonce area in each setting process, and
the nonce setting unit outputs the first data block to which the predetermined number of signatures are attached as a result of performing the setting process for the predetermined number of times.

9. The verification information attaching device according to claim 8, wherein
an average required time for setting process of one time, or the rule is determined on a basis of a propagation delay time with the external node.

10. The verification information attaching device according to claim 1, wherein
the nonce setting unit repeatedly performs the setting process once or a predetermined number of times on the first data block that includes a first data area in which arbitrary data is stored while sequentially adding a nonce area to be set as a nonce setting destination,
the nonce setting unit performs encryption, in which the secret key of the verification information attaching device is used, on an encryption target area that is a predetermined data area of the first data block that includes the nonce area each time a nonce that satisfies the rule is set to the nonce area as the setting destination by the setting process,
the nonce setting unit sets a nonce in the nonce area such that the process value satisfies the rule, the process value obtained from the first data block that includes the nonce area set as the setting destination and the first data area, in first setting process,
the nonce setting unit sets a nonce in the nonce area such that the process value obtained from the first data block satisfies the rule, for a new first data block that at least includes the nonce area set as the setting destination and an encrypted data area in which encrypted data obtained by immediately preceding encryption, in second and subsequent setting process, and
the nonce setting unit outputs a data block that at least includes encrypted data obtained by last encryption as a result of performing the setting process for the predetermined number of times.

11. A verification device that verifies a second data block that is a data block of a predetermined data structure that includes process data that is data obtained as a result of predetermined data process, the process data output from a verification information attaching device that includes a nonce setting unit that performs a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set, wherein the nonce setting unit performs a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process,
the verification device comprising
a verification unit that performs first verification process of verifying the process data included in the second data block by using a public key of the verification information attaching device that is a generation source of the second data block, and second verification process of verifying the second data block or data based on the second data block on a basis of the rule.

12. The verification device according to claim 11, wherein
the verification device verifies the second data block that is the data block output from the verification information attaching device that includes the nonce setting unit that performs signature or encryption, in which the secret key of the verification information attaching device is used, on the predetermined data area of the first data block that includes the nonce area each time a value is set to the nonce area in the setting process, determines whether or not the process value satisfies the rule, the process value obtained from the first data block to which the signature is attached in the setting process, or new first data block that includes encrypted data obtained by the encryption instead of data as a target of the encryption, and outputs a data block in which the process value is obtained in a case where the process value satisfies the rule, and
the verification unit verifies the signature and target data that is data as an attaching target of the signature included in the second data block, or the encrypted data, by using the public key, in the first verification process, and verifies whether or not the process value obtained from the second data block satisfies the rule, for the second data block that is the first data block to which the signature is attached, or new second data block that includes original data obtained by decrypting the encrypted data instead of the encrypted data, in the second verification process.

13. The verification device according to claim 11, wherein
the verification device verifies the second data block that is the data block output from the verification information attaching device that includes the nonce setting unit that repeatedly performs the setting process once or a predetermined number of times while designating one nonce area as a setting destination on the first data block that includes one or a predetermined number of nonce areas, performs signature, in which the secret key of the verification information attaching device is used, on a signature target area that is a predetermined data area of the first data block that includes the nonce area in which the nonce is set each time the nonce that satisfies the rule is set to the designated nonce area by the setting process, determines whether or not the process value satisfies the rule, the process value obtained from data of a rule target area that is a predetermined data area of the first data block that at least includes the nonce area and an area to which a signature attached immediately before is set, while setting a value in the designated nonce area in each setting process, and outputs the first data block to which the predetermined number of signatures are attached as a result of performing the setting process for the predetermined number of times,
the verification unit repeatedly performs the first verification process and the second verification process in this order the predetermined number of times while designating one of the signatures included in the second data block in reverse order of attached order, and
the verification unit verifies the designated signature included in the second data block, and target data that is data of the signature target area as an attaching target of the signature, by using the public key, in the first verification process of each time, and verifies whether or not the process value satisfies the rule, the process value obtained from data of the rule target area that includes the area in which the signature verified in the immediately preceding first verification process is set, in the second verification process of each time.

14. The verification device according to claim 11, wherein
the verification device verifies the second data block that is the data block output from the verification information attaching device that includes the nonce setting unit that repeatedly performs the setting process once or a predetermined number of times on the first data block that includes a first data area in which arbitrary data is stored while sequentially adding a nonce area to be set as a nonce setting destination, performs encryption, in which the secret key of the verification information attaching device is used, on an encryption target area that is a predetermined data area of the first data block that includes the nonce area each time a nonce that satisfies the rule is set to the nonce area as the setting destination by the setting process, sets a nonce in the nonce area such that the process value satisfies the rule, the process value obtained from the first data block that includes the nonce area set as the setting destination and the first data area, in first setting process, sets a nonce in the nonce area such that the process value obtained from the first data block satisfies the rule, for a new first data block that at least includes the nonce area set as the setting destination and an encrypted data area in which encrypted data obtained by immediately preceding encryption, in second and subsequent setting process, and outputs a data block that at least includes encrypted data obtained by last encryption as a result of performing the setting process for the predetermined number of times,
the verification unit repeatedly performs the first verification process and the second verification process in this order the predetermined number of times,
the verification unit decrypts encrypted data included in the second data block or new second data block obtained by the previous first verification process, by using the public key, and verifies a decryption result, and obtains new second data block that at least includes original data obtained by the decryption, in the first verification process of each time, and
the verification unit verifies whether or not the process value obtained from the new second data block obtained by the immediately preceding first verification process satisfies the rule, in the second verification process of each time.

15. An information management system comprising
a verification information attaching device and a verification device, wherein
the verification information attaching device includes a nonce setting unit that performs a setting process in which: in order for a process value obtained when a one-way function is applied to a first data block having a predetermined data structure that has a nonce area in which is set a nonce that is verification information, or applied to data based on the first data block, to satisfy a predetermined rule, a nonce is set to a predetermined nonce area of the first data block; and a value is set to the nonce area and the process value is actually computed, whereby the nonce is set,
the nonce setting unit performs a predetermined data process, in which a secret key of the verification information attaching device is used, on a predetermined data area of the first data block that includes the nonce area each time a value is set to the nonce area in the setting process or each time a nonce that satisfies the rule is set to the nonce area by the setting process, and
the verification device includes a verification unit that performs, on a second data block that is a data block of a predetermined data structure that includes process data that is data obtained as a result of the predetermined data process output from the verification information attaching device, first verification process of verifying the process data included in the second data block by using a public key of the verification information attaching device that is a generation source of the second data block, and second verification process of verifying the second data block or data based on the second data block on a basis of the rule.

16. (canceled)

17. (canceled)

18. The verification information attaching device according to claim 2, wherein
the nonce setting unit performs the data process in a tamper resistant area in which the secret key is not taken out externally.

19. The verification information attaching device according to claim 2, wherein
the nonce setting unit outputs a data block of a predetermined data structure that includes process data that is data obtained as a result of the data process, as a result of performing the setting process.

20. The verification information attaching device according to claim 3, wherein
the nonce setting unit outputs a data block of a predetermined data structure that includes process data that is data obtained as a result of the data process, as a result of performing the setting process.

21. The verification information attaching device according to claim 18, wherein
the nonce setting unit outputs a data block of a predetermined data structure that includes process data that is data obtained as a result of the data process, as a result of performing the setting process.

22. The verification information attaching device according to claim 2, wherein
the nonce setting unit performs signature or encryption, in which the secret key of the verification information attaching device is used, on the predetermined data area of the first data block that includes the nonce area each time a value is set to the nonce area in the setting process,
the nonce setting unit determines whether or not the process value satisfies the rule, the process value obtained from the first data block to which the signature is attached in the setting process, or new first data block that includes encrypted data obtained by the encryption instead of data as a target of the encryption, and
the nonce setting unit outputs a data block in which the process value is obtained in a case where the process value satisfies the rule.
